(19) United States
(12) Patent Application Publication
(10) Pub. No.: US 2025/0271787 A1
(43) Pub. Date: Aug. 28, 2025

(54) DEVELOPING DEVICE, IMAGE FORMING APPARATUS, SUPPLYING ROLLER, AND MANUFACTURING METHOD OF THE SUPPLYING ROLLER

(71) Applicant: CANON KABUSHIKI KAISHA, Tokyo (JP)

(72) Inventors: Yutaro Nakamura, Shizuoka (JP); Takayoshi Kihara, Shizuoka (JP)

(21) Appl. No.: 19/062,124

(22) Filed: Feb. 25, 2025

(30) Foreign Application Priority Data
Feb. 27, 2024 (JP) 2024-027522
Feb. 27, 2024 (JP) 2024-027523

(51) Int. Cl. G03G 15/08; G03G 15/00; G03G 21/14

(52) U.S. Cl. CPC G03G 15/0808; G03G 15/081; G03G 15/0889; G03G 15/6564; G03G 21/14; G03G 2215/0869

(57) ABSTRACT

A developing device includes a developer carrying member, a supplying roller, an accommodating chamber, a developing chamber, a development opening, a stirring shaft, and a stirring member. In an attitude in which the developing device is mounted in an image forming apparatus and opposite end portions of the supplying roller with respect to a longitudinal direction of the supplying roller are supported by a frame of the image forming apparatus, the development opening is provided above a rotation axis of the supplying roller, the stirring shaft is provided above the development opening, and the supplying roller is larger in absolute value of an air permeation amount in a central portion thereof with respect to the longitudinal direction than in a position of 1/10 of a length thereof from the end portion thereof.

### FIELD OF THE INVENTION AND RELATED ART

The present invention relates to a developing device, an image forming apparatus, a supplying roller, and a manufacturing method of the supplying roller, and relates to, for example, the developing device and a process cartridge which are used in the image forming apparatus, such as a copying machine, a printer or a facsimile machine, with use of an electrophotographic type or an electrostatic recording type, and the image forming apparatus including the developing device or the process cartridge.

Conventionally, in the image forming apparatus of the electrophotographic type, the developing device for forming a developer image by supplying a developer to an electrostatic latent image formed on an electrophotographic photosensitive member as an image bearing member. In such a developing method, for example, a one-component developer consisting only of toner is used. In the case of this developing method, the developing device is constituted principally by two spaces, and is divided into a toner accommodating chamber for accommodating the toner and a developing chamber for performing a developing process. The toner is supplied to the developing chamber through a development opening provided in a boundary between the toner accommodating chamber and the developing chamber by rotating a stirring member provided in the toner accommodating chamber. The developing chamber is constituted by a developing roller, a supplying roller, and a developing blade. The developing roller is a developer carrying member for performing development in which the toner is fed to a photosensitive drum and the developer image is formed on the photosensitive drum. The supplying roller is a developer supplying member which supplies the toner to the developing roller and which has a sponge structure for scraping off the toner from the developing roller. The developing blade is a regulating member provided in a periphery of the developing roller and for regulating a toner layer formed by the toner supplied from the supplying roller to the developing roller. Further, the supplying roller exhibits the above-described effect by that the supplying roller is contacted to and caused to enter a surface of the developing roller in a described predetermined amount by using an inter-axial fixing type or the like. The toner carried to the developing chamber is supplied onto the developing roller by the supplying roller, and is regulated by the developing blade. The toner passes through a contact portion between the developing roller and the developing blade, and then is fed (conveyed) to a developing region which is a region close to the photosensitive drum, so that the electrostatic latent image is visualized as a toner image.

When the toner is fed from the toner accommodating chamber to the developing chamber, in the case where there is a development opening positioned below a stirring member with respect to a vertical direction and a center of the supplying roller is positioned below the development opening with respect to the vertical direction, the toner is repetitively pushed into the developing chamber by rotation of the stirring member in some instances. In this case, there is a liability that the toner is easily clogged inside the developing chamber and thus toner motion is decreased. On the other hand, by the rotation of the stirring member, powder pressure by the toner is higher in a central portion than in opposite end portions.

For this reason, this phenomenon is conspicuously observed in an image central portion, i.e., a central portion of a photosensitive drum with respect to a rotational axis direction of the photosensitive drum from a viewpoint of toner circulation. When the toner motion in the developing chamber is decreased, supply and discharge of the toner cannot be normally performed. Specifically, compared with the opposite end portions with respect to a longitudinal direction, in the central portion, the toner motion is decreased, and therefore, the supplying roller cannot sufficiently incorporate the toner in a sponge layer, and thus cannot supply the toner to the developing roller. By this, for example, for a whole surface black image, an image defect such as improper toner followability, i.e., such a phenomenon that an image of which density is insufficient due to that the toner is not supplied from the supplying roller is formed (generated) in the central portion with a rotation cyclic period of the supplying roller or the developing roller in some instances.

As a solution of this problem, there is a method such that an air permeation amount of the supplying roller is increased for the purpose activating the action of the supplying roller by improving the toner circulation in the developing chamber. The air permeation amount is a parameter such that air of a predetermined pressure is passed through the supplying roller in a predetermined amount and an amount of the passed air is represented by a unit of L/min (liter(s) per minute). The supplying roller has a foam sponge structure as shown in FIG. 9, and a cell diameter and a degree of communication of the foam sponge structure are controlled a polymer viscosity, an amount of carbon dioxide, and a foaming condition of a material thereof.

The degree of communication is a degree of connection between cells. By adjusting the cell diameter and the degree of communication, the air permeation amount of the supplying roller can be controlled.

On the other hand, when the air permeation amount of the supplying roller is increased, an image defect such as a lateral band with an interval of the developing roller or the supplying roller (hereinafter, this lateral band is referred to as a supplying roller set) occurs. When the air permeation amount is increased, foaming of the sponge structure is enhanced, i.e., a cross-link structure is suppressed, and therefore, the supplying roller becomes soft and is liable deform.

Then, permanent deformation occurs in the case where the supplying roller is stored for a long term, so that a fluctuation in peripheral speed due to the permanent deformation occurs in a contact portion with the developing roller, particularly in opposite end portions with respect to the longitudinal direction, thus causing the image defect. As a countermeasure against the supplying roller set, there is a method in which the air permeation amount of the supplying roller is decreased.

Further, in order to improve a scraping-off performance of development residual toner by the supplying roller, a manufacturing method in which a density of an elastic layer (sponge portion) is made higher in a central portion than opposite end portions of the supplying roller with respect to the longitudinal direction is disclosed (for example, see Japanese Laid-Open Patent Application No. 2014-170028).

However, as described above, when the air permeation amount of the supplying roller is increased, there is a liability that when image formation is carried out after the supplying roller is left standing for a long term, the image defect such that the lateral band with the interval of the supplying roller (i.e., the supplying roller set) occurs. When the air permeation amount is increased, the foaming of the sponge structure is enhanced, i.e., the cross-linked structure is suppressed, and therefore, the supplying roller becomes soft and is liable to deform. As a result, in the contact portion with the developing roller, particularly in the opposite end portions with respect to the longitudinal direction, the peripheral speed fluctuation due to the permanent deformation occurs and causes the image defect. Further, in the opposite end portions, the following phenomenon also occurs. Here, FIG. 10 shows a state in which opposite ends of a developing roller 1041 and supplying roller 1043 are supported and fixed by a frame 1001 of an image forming apparatus. In the opposite end portions (broken-line regions β) of the supplying roller 1043, the opposite ends of the supplying roller 1043 are fixed by the frame 1001, and therefore, the opposite end portions cannot be fluxed differently from the central portion, so that a state in which the supplying roller is pressed against the developing roller is maintained. When such a state is maintained, a component of an ion conductive agent bleeds out from the supplying roller, and the bleed-out component inhibits supply of the toner from the supplying roller to the developing roller. Then, as a result, the image defect such that an original image density cannot be obtained is caused. Also, in this case, this phenomenon occurs with a rotation cyclic period of the developing roller or the supplying roller.

### SUMMARY OF THE INVENTION

The present invention has been accomplished in the above-described circumstances. A principal object of the present invention is to reduce a degree of an occurrence of an image defect even in a state in which an air permeation amount of a supplying roller is increased.

In order to solve the above-described problems, the present invention is provided with the following constitutions.

(1) According to an aspect of the present invention, there is provided a developing device comprising: a developer carrying member configured to carry a developer and configured to form a developer image by developing an electrostatic latent image with the developer; a supplying roller configured to supply the developer to the developer carrying member in contact with the developer carrying member; an accommodating chamber configured to hold the developer; a developing chamber including the developer carrying member and the supplying roller; a development opening configured to partition the developing chamber and the accommodating chamber; a stirring shaft provided in the accommodating chamber; and a stirring member configured to stir the developer by being rotated about the stirring shaft in the accommodating chamber, wherein in an attitude in which the developing device is mounted in the image forming apparatus and in which opposite end portions of the supplying roller with respect to a longitudinal direction of the supplying roller are supported by a frame of the image forming apparatus, the development opening is provided above a rotation axis of the supplying roller, the stirring shaft is provided above the development opening, and the supplying roller is larger in absolute value of an air permeation amount in a central portion thereof with respect to the longitudinal direction than in a position of 1/10 of a length thereof from each of the opposite end portions thereof.
(2) According to another aspect of the present invention, there is provided an image forming apparatus for forming an image on a recording material, comprising: an image bearing member configured to bear an electrostatic latent image; and a developing device according to the developing device described in the above-described (1), configured to develop the electrostatic latent image.
(3) According to another aspect of the present invention, there is provided a supplying roller for supplying a developer to a developer carrying member in contact with the developer carrying member, comprising: a central portion with respect to a longitudinal direction; and opposite end portions with respect to the longitudinal direction, wherein in an attitude in which the supplying roller is mounted in an image forming apparatus and in which the opposite end portions are supported by a frame of the image forming apparatus, an absolute value of an air permeation amount in the central portion is larger than an absolute value of an air permeation amount in a position of 1/10 of a length of the supplying roller in the longitudinal direction from the end portion.
(4) According to another aspect of the present invention, there is provided a manufacturing method of a supplying roller for supplying a developer to a developer carrying member in contact with the developer carrying member, comprising: a step of undercoating a rod core metal with an adhesive; a step of inserting the rod core metal into a first sponge roller having a first air permeation amount and a second sponge roller having a second air permeation amount smaller than the first air permeation amount so that the first sponge roller is provided in a central portion of the rod core metal with respect to a longitudinal direction of the rod core metal and the second sponge roller is provided in opposite end portions of the rod core metal with respect to the longitudinal direction; and a step of bonding the second sponge roller disposed in one end portion with respect to the longitudinal direction and the first sponge roller together and bonding the second sponge roller disposed in the other end portion with respect to the longitudinal direction and the first sponge roller together.
(5) According to a further aspect of the present invention, there is provided an image forming apparatus comprising: an image bearing member configured to bear an electrostatic latent image; a developer carrying member configured to carry a developer and configured to form a developer image by developing the electrostatic latent image with the developer; a supplying roller configured to supply the developer to the developer carrying member in contact with the developer carrying member; a regulating member configured to regulate the developer carried on the developer carrying member; an accommodating chamber configured to hold the developer; a developing chamber including the developer carrying member, the supplying roller, and the regulating member; a development opening configured to partition the developing chamber and the accommodating chamber; a stirring shaft provided in the accommodating chamber; a stirring member configured to stir the developer by being rotated about the stirring shaft in the accommodating chamber, wherein the development opening is provided above a rotation axis of the supplying roller, the stirring shaft is provided above the development opening, and the supplying roller is larger in absolute value of an air permeation amount in a central portion thereof with respect to a longitudinal direction of the supplying roller than in opposite end portions thereof with respect to the longitudinal direction; and a controller configure to carry out control in which toner is discharged to an end portion region of the image bearing member with respect to a longitudinal direction of the image bearing member by the developer carried on the developer carrying member.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus of embodiments 1 to 4.

FIG. 2 is a schematic sectional view of a process cartridge in the embodiments 1 to 4.

FIG. 3 is a schematic sectional view of a developing device of the embodiments 1 to 4.

Part (a) of FIG. 4 is a schematic sectional view of a supplying roller of the embodiments 1 to 4, and part (b) of FIG. 4 is a schematic view for illustrating a measuring method of an air permeation amount of the supplying roller.

Part (a) of FIG. 5 is a graph showing a relationship between the air permeation amount of the supplying roller and an incorporation amount of toner after black in the embodiments 1 to 4, and part (b) of FIG. 5 is a graph showing a relationship between the air permeation amount of the air permeation amount of the supplying roller and a deformation amount after standing in a service environment in the embodiments 1 to 4.

Parts (a) to (c) of FIG. 6 are schematic views for illustrating a method 1 for changing the air permeation amount with respect to a longitudinal direction in the embodiments 1 to 4.

FIG. 7 is a schematic view for illustrating a method 2 (crushing step) for changing the air permeation amount with respect to the longitudinal direction in the embodiments 1 to 4.

Part (a) of FIG. 8 is a graph showing a relationship between the air permeation amount and a ratio (density ratio) of a trailing end density to a leading end density in the embodiment 1, and part (b) of FIG. 8 is a graph showing a relationship between the air permeation amount and a deformation amount of the supplying roller in the embodiment 1.

FIG. 9 is a schematic view showing a sponge structure of a supplying roller of a comparison example.

FIG. 10 is a schematic view showing a supporting constitution of opposite end portions of the supplying roller.

FIG. 11 is a schematic view showing a neighborhood of one end portion of a developing device of the embodiment 1 with respect to a longitudinal direction.

FIG. 12 is a flowchart showing processing for suppressing toner scattering in the embodiment 1.

FIG. 13 is a flowchart showing processing for suppressing toner end portion scattering in the embodiment 2.

FIG. 14 is a flowchart showing processing for suppressing toner end portion scattering in the embodiment 3.

FIG. 15 is a flowchart showing processing for suppressing toner end portion scattering in the embodiment 4.

### DESCRIPTION OF THE EMBODIMENTS

A developing device, a process cartridge, and an image forming apparatus according to the present invention will be specifically described with reference to the drawings. In the following, with reference to the drawings, embodiments for carrying out the present invention will exemplarily described based on specific embodiments. However, dimensions, material, shapes, relative arrangement of constituent elements described in the following embodiments should be appropriately changed depending on constitutions various conditions of apparatuses or devices with the present invention is applied. That is, the scope of the present invention is not intended to be limited to the following embodiments.

### Embodiment 1

### (General Constitution and Operation of Image Forming Apparatus]

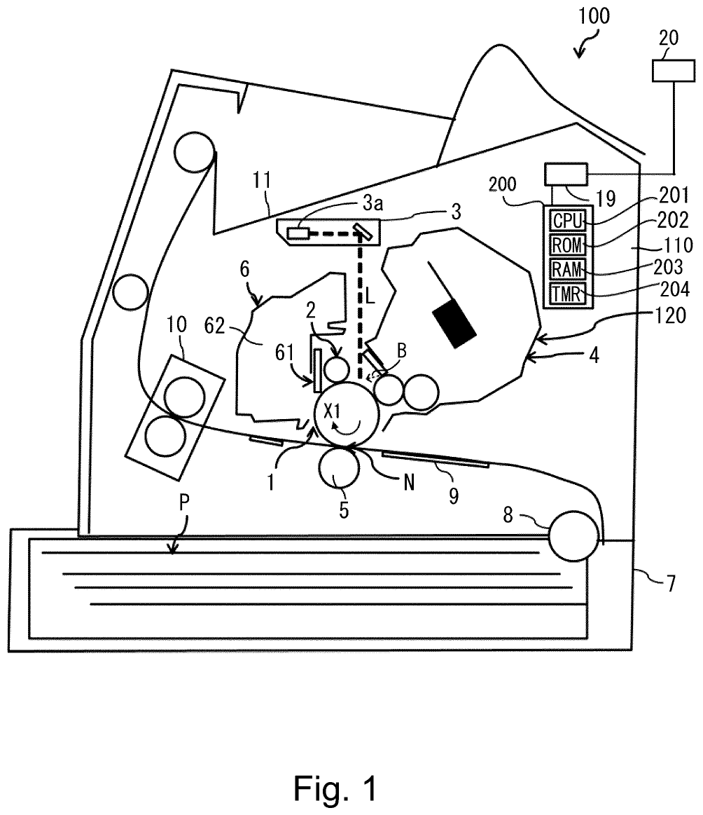

FIG. 1 is a schematic sectional view of an image forming apparatus of embodiments 1 to 4. An image forming apparatus 100 is a laser beam printer for forming an image by using an electrophotographic type. The image forming apparatus 100 employs a cartridge type, and a process cartridge 120 is made detachably mountable to an apparatus main assembly 110. To the image forming apparatus 100, an external host device such as a personal computer or an image reading apparatus is connected. The image forming apparatus 100 receives image information from the host device, and an image depending on the received image information is formed and outputted (printed) on a recording material (recording medium, transfer material). As the recording material, a sheet material such as paper may preferably be used.

The image forming apparatus 100 includes a photosensitive drum 1 which is a drum-shaped (cylindrical) electrophotographic photosensitive member (photosensitive member) as an image bearing member. At a periphery of the photosensitive drum 1, along a rotational direction (X1) of the photosensitive drum 1, the following members are sequentially provided. First, a charging roller 2 which is a roller-shaped charging member as a charging means is provided. Next, an exposure device (laser scanner unit) 3 as an exposure means is provided. Next, a developing device 4 as a developing means is provided. Next, a transfer roller 5 which is a roller-shaped transfer member as a transfer means is provided. Next, a cleaning device 6 as a cleaning means is provided.

When a print start signal is inputted to the image forming apparatus 100 and image formation is started, to the photosensitive drum 1, a driving force from a driving motor (not shown) as a driving means provided in the apparatus main assembly 110 is transmitted. By this, the photosensitive drum 1 is rotationally driven at a predetermined peripheral speed (process speed) (for example, 300 mm/s) in an arrow X1 direction in FIG. 1. In this embodiment, the photosensitive drum 1 includes a drum substrate made of aluminum and an OPC photosensitive layer provided on the drum substrate. The charging roller 2 is disposed in contact with the photosensitive drum 1 and is rotated with rotation of the photosensitive drum 1. A surface (outer peripheral surface) of the rotating photosensitive drum 1 is electrically charged substantially uniformly to a predetermined polarity (negative polarity in this embodiment) and a predetermined potential by the charging roller 2. At this time, to the charging roller 2, a predetermined charging voltage is applied from an unshown charging power source (high-voltage power source) provided in the apparatus main assembly.

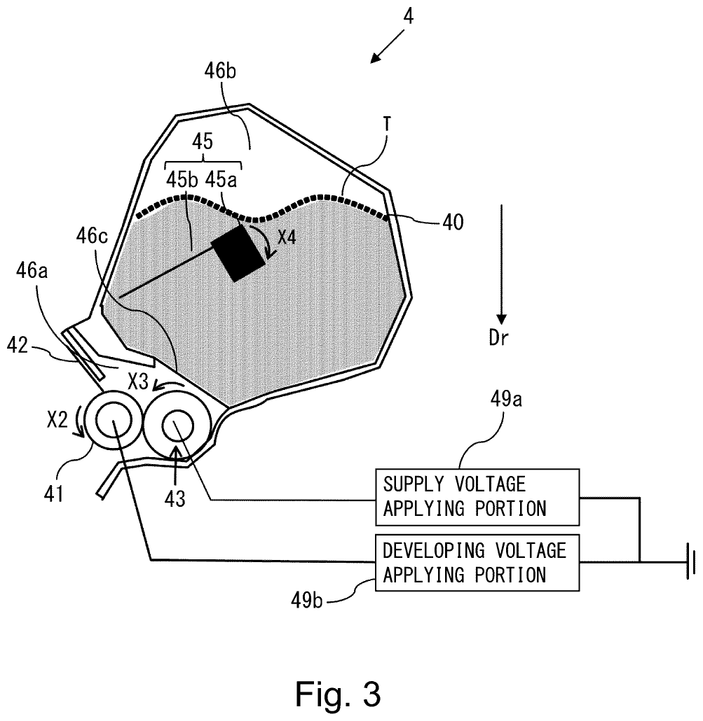

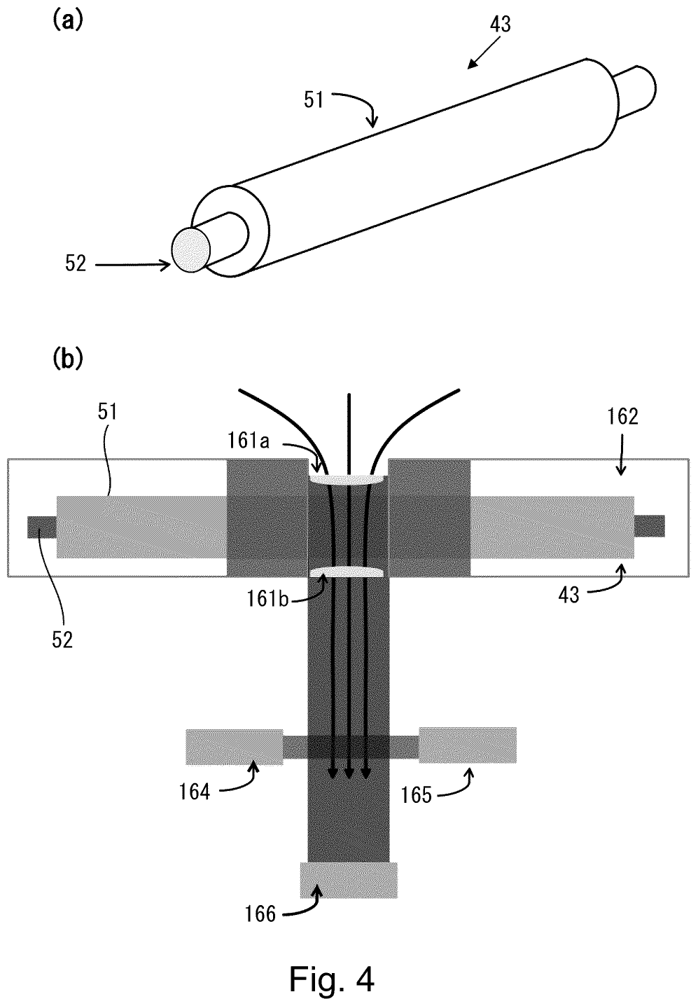

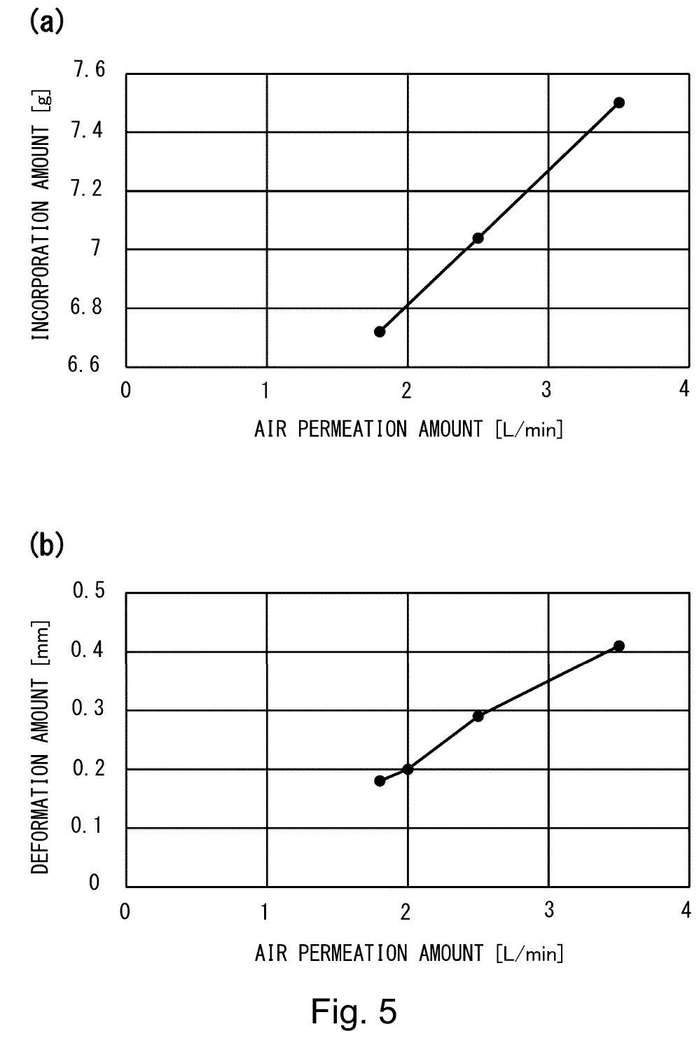

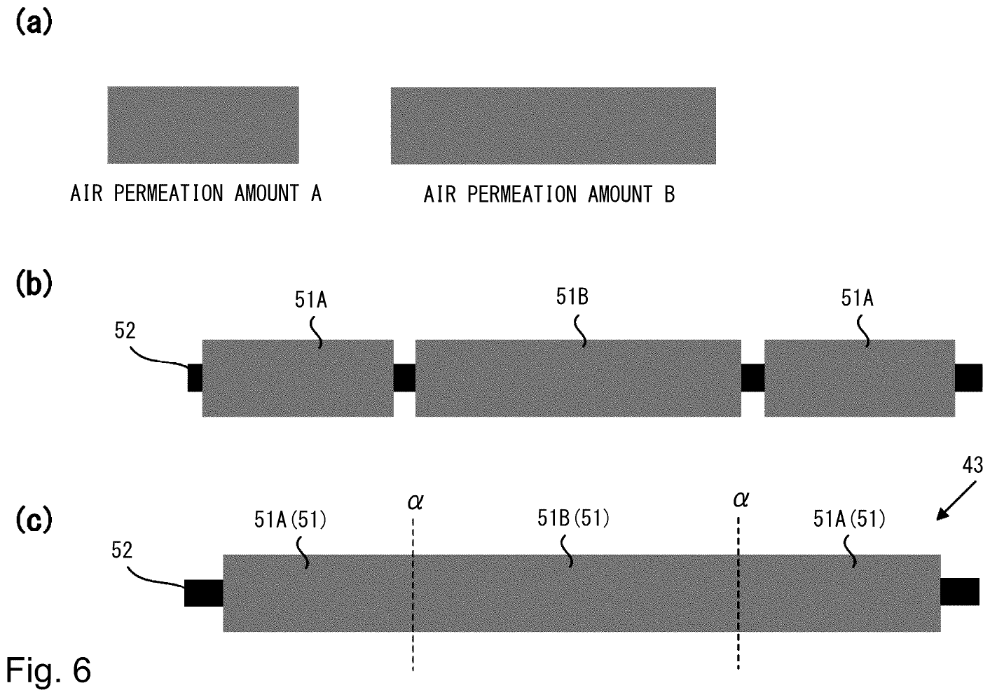

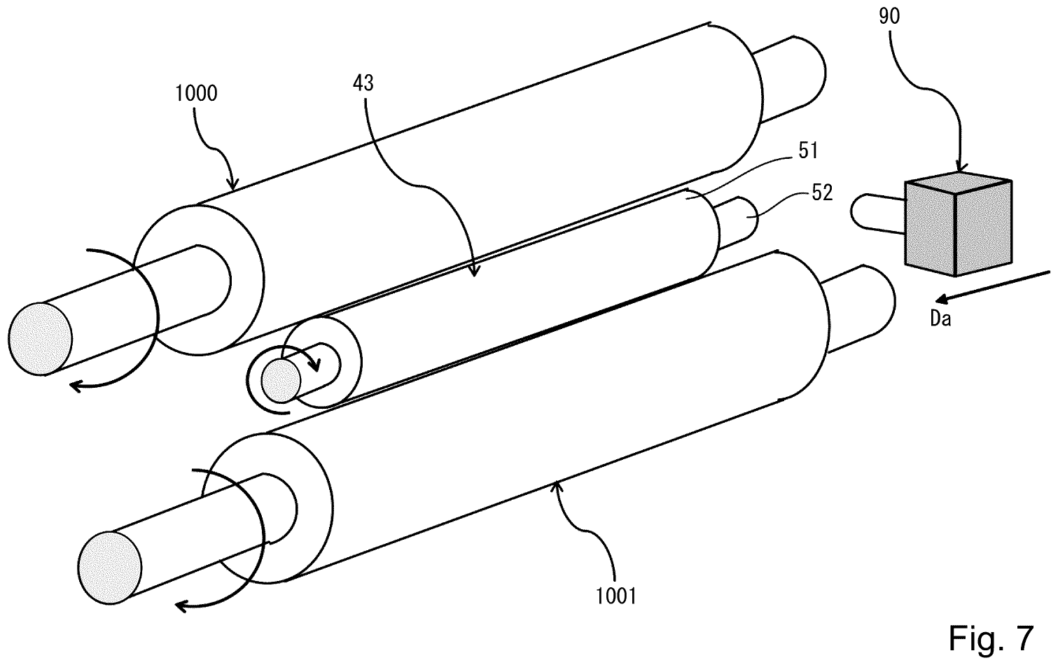

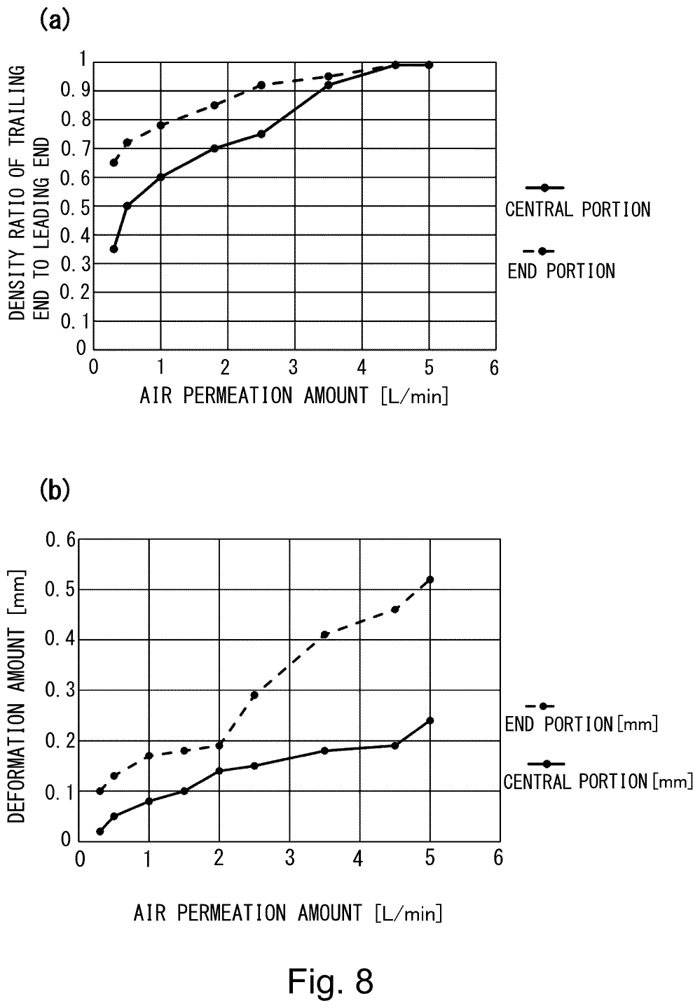

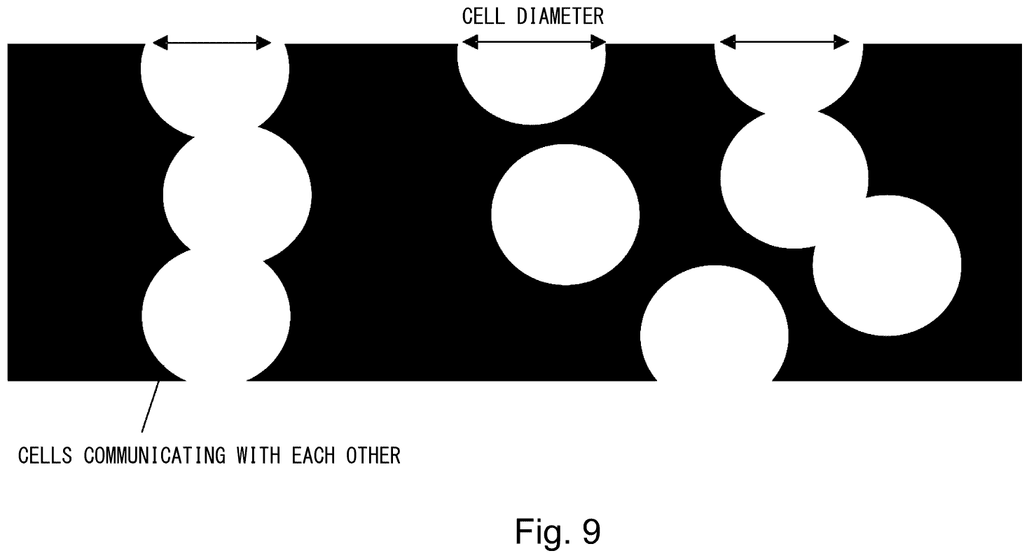

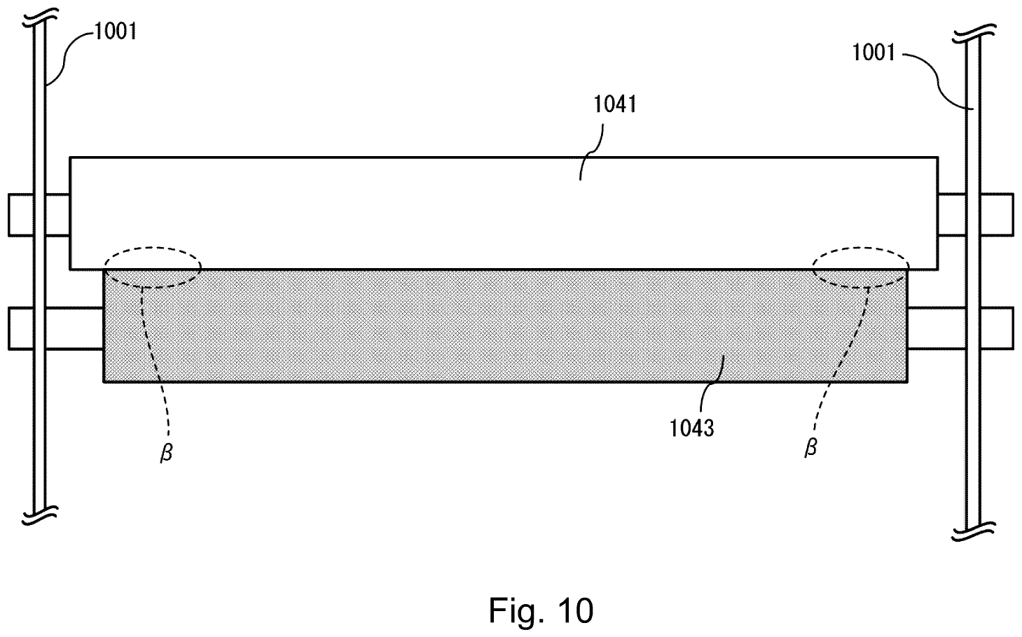

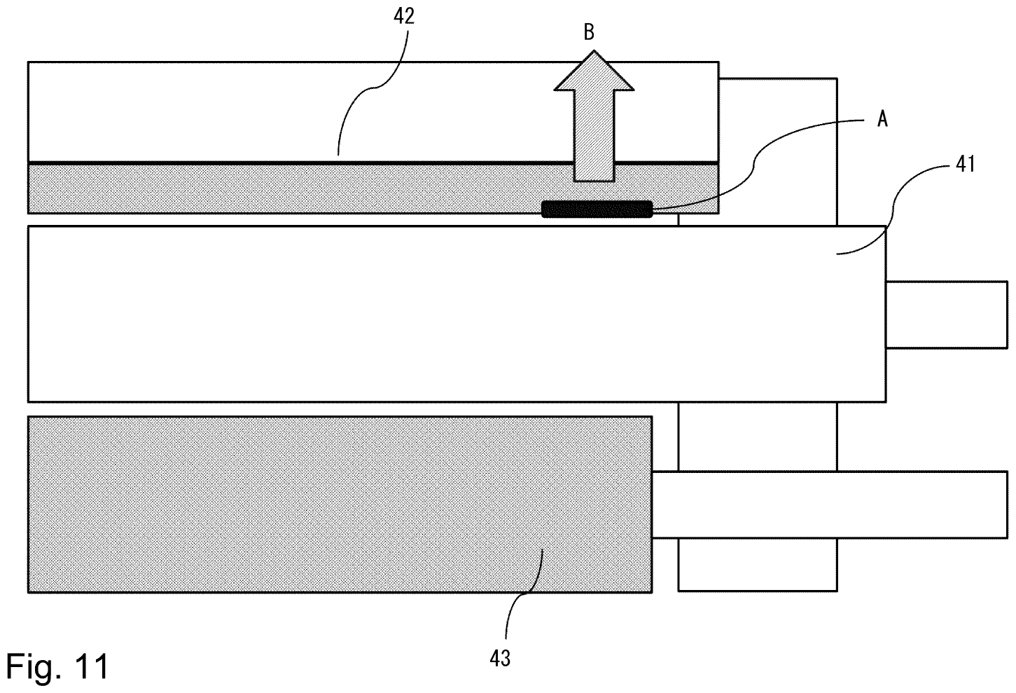

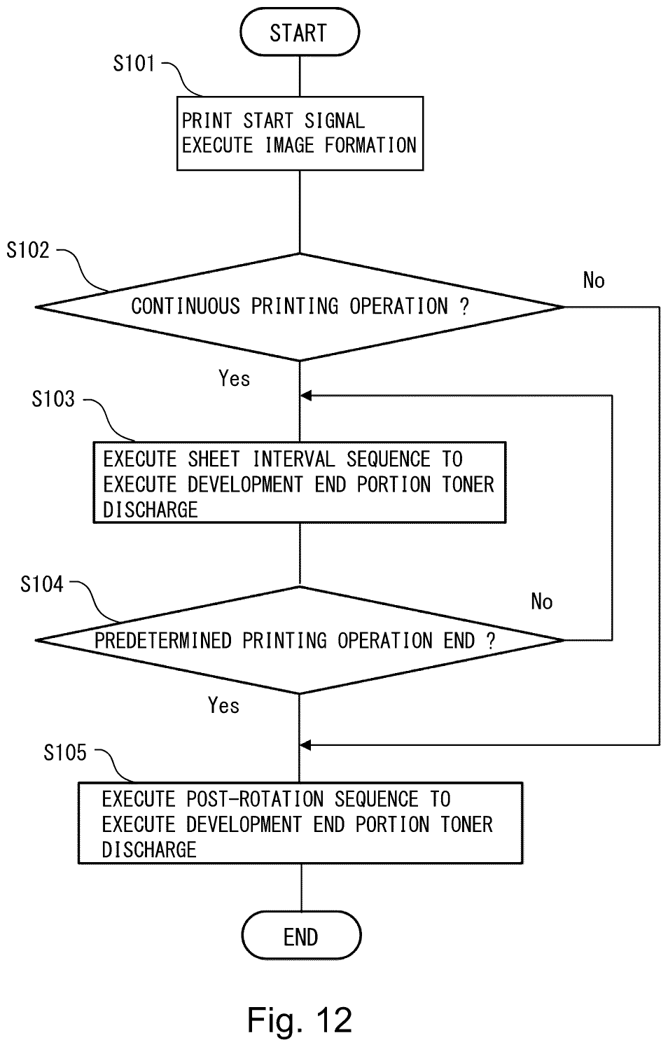

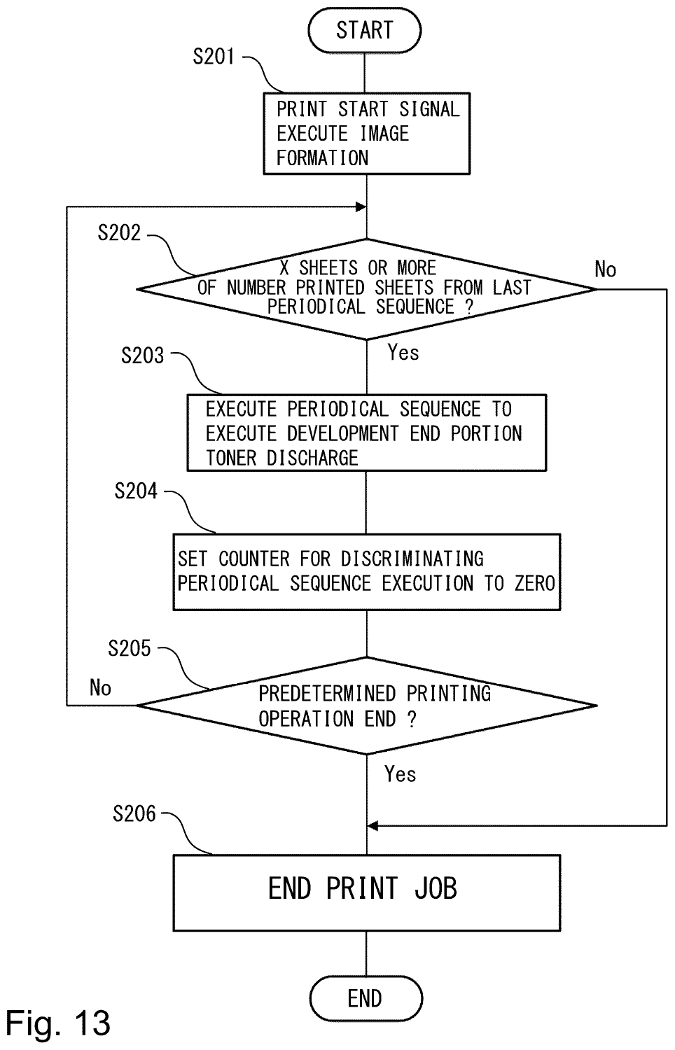

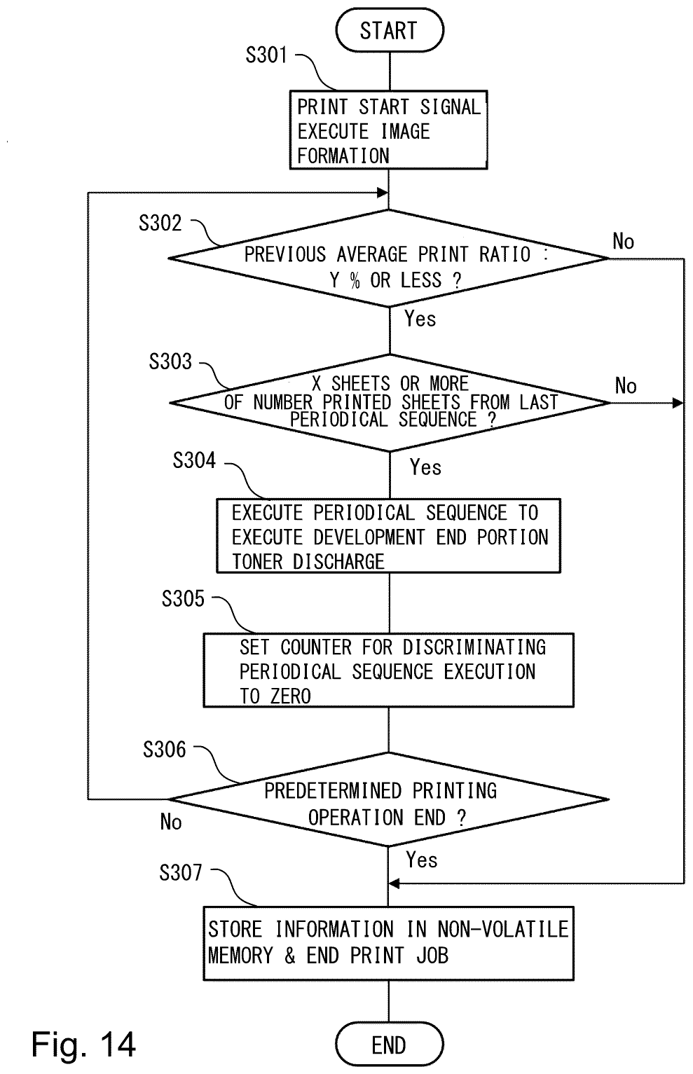

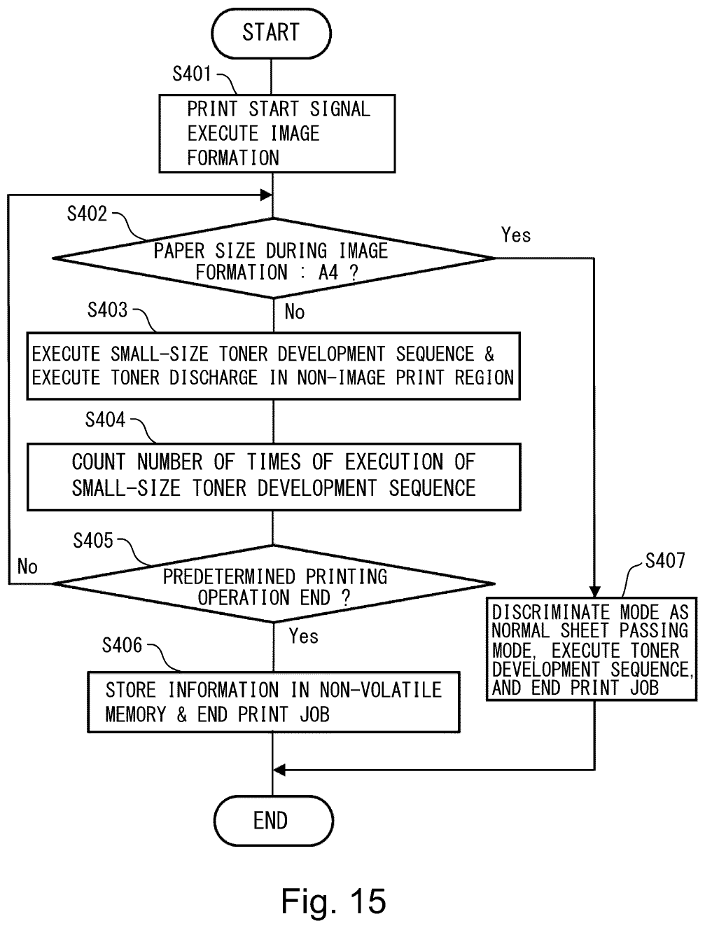

The charged surface of the photosensitive drum 1 is exposed to laser light L depending on image information from the exposure device 3. The exposure device 3 outputs, from a laser outputting portion 3a, the laser light (exposure beam) L modulated correspondingly to a time-series electric digital image signal of the image information inputted from a personal computer 20 or the like to a video controller 19. The laser light L outputted from the exposure device 3 enters an inside of the process cartridge 120, so that the surface of the photosensitive drum 1 is irradiated with the laser light L. The surface of the photosensitive drum 1 charged substantially uniformly is subjected to scanning exposure to the laser light L, whereby an electrostatic latent image (electrostatic image) corresponding to the image information is formed on the surface of the photosensitive drum 1. The electrostatic latent image is developed with toner T (see FIG. 3) as a developer by the developing device 4. Details of the developing device 4 will be described later.

On the other hand, a pick-up roller 8 as a feeding means is driven at a predetermined control timing, and a recording material P such as a recording sheet or the like stacked and accommodated in a tray 7 as a recording material accommodating portion is separated and fed one by one. By this, to a transfer portion N, the recording material P is fed (conveyed) at a predetermined control timing by a feeding (conveying) means (not shown). Further, the transfer roller 5 forms a transfer portion (transfer nip) N in contact with the surface of the photosensitive drum 1 with a predetermined pressing force. The recording material P is fed to the transfer portion N via a transfer guide 9 as a guiding member. Further, in a process in which the recording material P passes through the transfer portion N by being nipped and fed by the photosensitive drum 1 and the transfer roller 5, a toner image as a developer image on the surface of the photosensitive drum 1 is electrostatically transferred. At this time, to the transfer roller 5, a transfer voltage which is a DC voltage of a polarity opposite to a charge polarity (negative polarity in this embodiment) of the toner during development is applied from an unshown transfer power source (high-voltage power source) provided in the apparatus main assembly 110.

The recording material P on which the toner image is transferred is separated from the photosensitive drum 1 is fed to a fixing device 10 as a fixing means provided on a side downstream of the transfer portion N with respect to a feeding (conveying) direction of the recording material P. The recording material P is subjected to a fixing process of an unfixed toner image by being heated and pressed in the fixing device 10.

In this embodiment, the fixing device 10 includes a heating (fixing) roller provided with a halogen heater therein and a pressing roller press-contacted to the heating roller. Further, the fixing device 10 heats and presses the toner image, transferred on the surface of the recording material P, while nipping and feeding the recording material P in a fixing nip between the fixing roller and the pressing roller. By this, the toner image is melted and fixed on the surface of the recording material P. Thereafter, the recording material P is discharged on a discharging tray 11 provided in an upper portion of the apparatus main assembly 110 in FIG. 1.

The surface of the photosensitive drum 1 after the recording material P is separated is cleaned by the cleaning device 6, and is repetitively subjected to an image forming process starting from the above-described charging. By a cleaning blade 61 as a cleaning member provided in contact with the photosensitive drum 1, the cleaning device 6 removes a deposited matter such as toner remaining on the surface of the photosensitive drum 1 without being transferred during the transfer from the surface of the rotating photosensitive drum 1, and then collects the deposited matter in a collected toner container 62.

Incidentally, the image forming apparatus 100 includes a controller 200 as a control means. The controller 200 controls entirety of the above-described image forming operation, and includes a CPU201, a ROM202, a RAM203, and a timer 204. The CPU201 executes a program stored in advance by using various parameters stored in advance in the ROM202, and thus carries out control relating to the above-described image formation while using the RAM203 as a temporary operation area. The CPU201 manages a time by using the timer 204 in timing control when various pieces of control are carried out.

### (Process Cartridge)

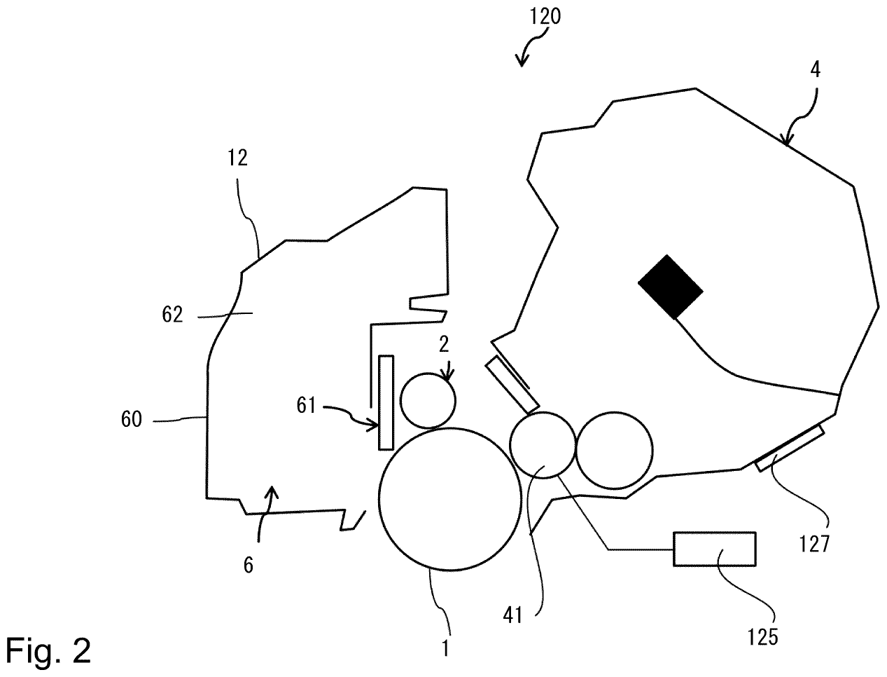

FIG. 2 is a schematic sectional view of the process cartridge 120. In this embodiment, the photosensitive drum 1, and as process means actable on the photosensitive drum 1, the charging roller 2, the developing device 4, and the cleaning device 6 are integrally assembled into a cartridge, so that the process cartridge 120 detachably mountable to the apparatus main assembly 110. The process cartridge 120 is constituted by connecting a cleaning unit 12 and the developing device 4 (also referred to as a developing unit) which is separate unit from the cleaning unit 12. The cleaning unit 12 includes the photosensitive drum 1, the charging roller 2, and the cleaning device 6. Further, the cleaning unit 12 includes a cleaning frame 60 for forming the collected toner container 62 and for supporting the photosensitive drum 1, the charging roller 2, and the cleaning blade 61. Details of the developing device 4 will be described later.

The process cartridge is prepared by integrally assembling the image bearing member such as the photosensitive member and the process means actable on the image bearing member into a cartridge, which is made detachably mountable to the apparatus main assembly of the image forming apparatus. As the process means, it is possible to cite a charging means, a developing means, a cleaning means, a toner charging means for charging transfer residual toner, and the like. Here, the process cartridge is prepared by integrally assembling at least a developer container or the developing device, and the image bearing member into a cartridge, which is made detachably mountable to the apparatus main assembly of the image forming apparatus.

Further, the process cartridge 120 or the developing device 4 includes a non-volatile memory 127. In the RAM203 and/or the non-volatile memory 127, information on the process cartridge 120 or the developing device 4 is stored. For example, whether or not an article is a new article, a model number, a consumption amount or a remaining amount of the toner T, a total number of printed sheet from a new article state, a total number of rotations of a rotatable member, a total traveling distance converted from the number of rotations, an average print ratio, and the like are stored in the RAM203 and/or the non-volatile memory 127. In the RAM203 and/or the non-volatile memory 127, a toner consumption amount per dot Xo for converting from a dot number of the image formed on the photosensitive drum to a toner consumption amount is also stored.

A developing roller 41 in this embodiment is capable of taking a state (contact state) in which the developing roller 41 is contacted to the photosensitive drum 1 or a state (separated state) in which the developing roller 41 is separated from the photosensitive drum 1. The image forming apparatus 100 is provided with a contact and separation mechanism 125, and the controller 200 causes the contact and separation mechanism 125 to perform a contact and separation operation by displacing a position (relative position, attitude) of the developing device 4 which is the developing unit relative to the cleaning unit 12. The controller 200 puts the developing device 4 in the contact state when the toner is supplied to the photosensitive drum 1 by the developing roller 41, and puts the developing device 4 in the separation state when the toner is not supplied to the photosensitive drum 1. By this, although there is no need to supply the toner to the photosensitive drum 1, it is possible to reduce a degree of deformation or the like of the developing roller 41 and the photosensitive drum 1 due to contact therebetween. FIG. 2 shows the contact state.

### (Developing Device)

FIG. 3 is a schematic sectional view of the developing device 4 of this embodiment. The developing device 4 of this embodiment includes a developing chamber 46a, a toner accommodating chamber 46b for accommodating a developer, and a development frame 40 for supporting elements described later. The toner as the developer used in this embodiment is the toner T which is a one-component developer and which contains a magnetic material therein. In the toner accommodating chamber 46b, a stirring portion 45 including a stirring shaft 45a and a stirring sheet 45b which is a stirring member is provided, and the stirring portion 45 is rotated in an arrow X4 direction in FIG. 3 and feeds the toner T to the developing chamber 46a.

The developing chamber 46a is provided with a development opening (portion) 46c in a boundary with the toner accommodating chamber 46b. Further, in the developing chamber 46a, the developing roller 41 which is a cylindrical member as a developer carrying member is disposed. The developing roller 41 is rotatably supported by the development frame 40 in opposite end portions with respect to a longitudinal direction (rotational axis direction). The developing roller 41 is disposed in contact with the photosensitive drum 1. The developing roller 41 is rotationally driven in an arrow X2 direction in FIG. 3 by transmitting thereto a rotation driving force from a driving motor (not shown) provided in the apparatus main assembly 110. To the developing roller 41, a developing voltage necessary to develop the electrostatic latent image into the toner image is applied from a developing voltage applying portion 49b as a developing voltage applying means.

On a peripheral surface of the developing roller 41, a supplying roller 43 rotatable in an arrow X3 direction in FIG. 3 in contact with the developing roller 41 is provided. To the supplying roller 43 as a supplying member, a desired voltage is applied from a supplying voltage applying portion 49a as a supplying voltage applying means. Further, in the developing chamber 46a, a developing blade 42 which is a regulating member formed by an elastic member is provided so as to contact an outer peripheral surface of the developing roller 41. The developing blade 42 is supported by the development frame 40.

Next, the developing roller 41, the supplying roller 43, and the developing blade 42 will be described. The developing roller 41 is prepared by forming a surface layer of an urethane rubber on a base layer of a silicone rubber formed on an electroconductive core metal. On the surface layer of the developing roller 41, coarse particles are provided, so that a toner application amount is made appropriate. The supplying roller 43 is an electroconductive sponge roller having an urethane sponge structure such that a foamable layer is formed on an electroconductive core metal. The developing blade 42 is prepared by laminate-coating a SUS metal plate with a resin in a long side portion which becomes a free end in contact with the developing roller 41. Incidentally, as described above with reference to FIG. 10, each of the developing roller 41 and the supplying roller 43 is supported (fixed) by a frame (not shown) of the image forming apparatus 100 in opposite end portions with respect to the longitudinal direction.

The developing roller 41 and the photosensitive drum 1 are rotated so that surfaces thereof more in the same direction in an opposing portion (contact portion, developing region). Incidentally, in this embodiment, the developing roller 41 is disposed in contact with the photosensitive drum 1, but the developing roller 41 may be constituted so as to be disposed close to the photosensitive drum 1 with a predetermined interval.

The photosensitive drum 1 is electrically grounded, and from the developing voltage applied to the developing roller 41, an electric field is generated in a region between the photosensitive drum 1 and the developing roller 41. The charged toner T fed to the developing region is transferred onto the surface of the photosensitive drum 1 depending on the electrostatic latent image on the surface of the photosensitive drum 1 by the action of this electric field. By this, the electrostatic latent image on the photosensitive drum 1 is developed with the toner T. In this embodiment, the photosensitive drum 1 is charged uniformly and then is exposed to the light, so that the toner T charged to the same polarity (negative polarity) as the charge polarity of the photosensitive drum is deposited on an exposure portion (image portion) on the photosensitive drum 1 attenuated in absolute value of a potential. By this, the electrostatic latent image on the photosensitive drum 1 is developed with the toner T (reverse development type).

Incidentally, in this embodiment, as the developer, negatively chargeable T was employed, but positively chargeable toner may be used. In this embodiment, toner containing a magnetic material of 1.45 g/cm³ in specific gravity was used.

Motion of the toner in the developing container, i.e., toner flowability can be grasped by a physical parameter which is an agglomeration degree. The agglomeration degree is an index indicating ease of agglomeration of the toner. The toner flowability becomes worse when a numerical value of the agglomeration degree is high, and becomes better when the numerical value is low.

### (Supplying Roller)

The supplying roller 43 includes an electroconductive shaft body and a sponge layer formed on the shaft body and containing a cross-linked urethane resin. The supplying roller 43 shown in part (a) of FIG. 4 includes an electroconductive shaft body 52 and a sponge layer 51, provided on an outer periphery thereof, containing the cross-linked urethane resin. Incidentally, a layer structure of the supplying roller 43 is not limited to a layer structure such that the sponge layer 51 is present at an outermost surface of the supplying roller 43. As the supplying roller 43, it is also possible to cite a supplying roller such that a surface layer is formed on the sponge layer 51 provided on the outer periphery of the shaft body 52, and a supplying roller such that an elastic layer is provided between the shaft body 52 and the sponge layer 51. Further, the sponge layer 51 may contain an electroconductive agent and then may be molded. This can also be expected that a potential difference is generated by applying a voltage or the like to the developing roller 41 and thus a performance required as the supplying roller 43 can be improved. As the supplying roller 43, it is only required to have a constitution such that the supplying roller 43 has ability of scraping off the development residual toner on the developing roller 41 and then supplying the toner again. In the following, the constitution of the supplying roller according to an embodiment of the present invention will be described specifically.

### <Shaft Body>

The shaft body 52 functions as a supporting member and an electrode of the supplying roller 43. The shaft body 52 is constituted by an electroconductive material including metal or alloy such as aluminum, copper alloy, or stainless steel; iron plated with chromium or nickel; and synthetic resin having electroconductivity. The shaft body 52 has a solid columnar shape or a hollow cylindrical shape.

### <Sponge Layer>

The sponge layer 51 (foam layer) contains the cross-linked urethane resin described later. The sponge layer 51 may preferably have voids capable of storing toner particles therein in order to supply, as the supplying roller 43, the toner particles uniformly to the developing roller 41. As an example of the voids, it is possible to cite a large number of penetrating or non-penetrating pores (holes). Further, as another example of the voids, a porous material in a bubble (open-cell) state in which bubbles are connected to each other. In the case where the voids are bubbles as shown in FIG. 9, a size of a single bubble (cell) is expressed as a cell diameter. The sponge layer 51 containing the cross-linked urethane resin may preferably be in an open-cell state large in voids. Physical properties such as an absolute value surface cell diameter, a number of cells, an air permeation amount, a density of entirety of the layer, and the like of the sponge layer 51 including such voids become important. The physical properties of the sponge layer 51 are not particularly limited, but may preferably have values falling within the following numerical-value ranges.
Average surface cell diameter: 100 μm or more and 500 μm or less
Number of cells: 50 particles/inch or more and 450 particles/inch or less
Air permeation amount: 0.5 L/min or more and 4.5 L/min or less
Density: 0.05 g/cm³ or more and 0.45 g/cm³ or less

A lower limit of the air permeation amount is a minimum value at which the toner entered the cell is readily discharged to an outside of the cell, and an upper limit of the air permeation amount is a maximum value at which the toner can be appropriately supplied to the developing roller 41 and residual toner on the developing roller 41 can be appropriately scraped off.

Further, in measurement of the air permeation amount, it is possible to employ a measured value by the following measuring method. As shown in part (b) of FIG. 4, on a sliding surface of a cylindrical member 162 having an inner diameter smaller than an outer diameter of an electroconductive layer, for example, having an inner diameter smaller than the outer diameter by 1 mm, a measuring jig provided with a pair of through holes 161a and 161b each having an opening diameter of 1 cm is prepared in symmetrical positions with respect to a center axis of the cylindrical member 162. Into this measuring jig, the supplying roller 43 is inserted, and the electroconductive layer is sealed with a sealing material in a portion where the electroconductive layer is not coated with the cylindrical member 162. One through hole 161b of the cylindrical member 162 is connected to a suction pump 166 provided with a pressing gate 164 and a flowmeter 165. The other through hole 161a of the cylindrical member 162 is put under atmosphere pressure (101.3 kPa), and the suction pump 166 is driven, so that the atmospheric pressure is reduced to 125 Pa. An air flow rate measured by the flowmeter 165 at this time can be used as the air permeation amount. This measurement can be made not only in a central portion with respect to a longitudinal direction, but also in a whole area with respect to the longitudinal direction.

An adjusting method of the air permeation amount is not limited, and the air permeation amount can be adjusted by a conventionally well-known method. For example, in the case where the air permeation amount is adjusted by a foam elastic layer formed of an ingredient composition containing a polyol, a polyisocyanate, a foaming agent, a catalyst, a foam stabilizer, and the like, into the surface layer, the foam stabilizer having strong action of communicating cells (air bubble) with each other, so that a cell structure high in communication property can be obtained. For example, a commercially available product such as “L-3415” (trade name, manufactured by Momentive Performance Materials Japan LLC) or “F-606” (trade name, Shin-Etsu Chemical Co., Ltd.) may preferably be used.

Of course, the air permeation amount of the sponge layer can be adjusted in a component other than the above-described foam stabilizer, and depending on, for example, an addition amount of the foaming agent or a kind and an addition amount of the catalyst, by adjusting foaming reaction and curing reaction, the air permeation amount can be adjusted. In the case where the air permeation amount is intended to be increased, the curing reaction is suppressed and the foaming reaction may only be required to be accelerated. Further, besides the adjustment of the material component, the air permeation amount can be adjusted by a method in which a roller is rotated by applying load stress to the sponge layer, a manufacturing method in which open (communication) cells excellent in air permeable property are formed by breaking a film forming a cell skeleton in the neighborhood of a surface layer through blowing high pressure air, and the like method.

### (Supplying Roller Manufacturing (Preparing) Method)

The supplying roller 43 in this embodiment is molded by the following manufacturing method, for example. A roller molding mold formed by holding an iron cylindrical member on which inner surface a parting agent is applied and which has an inner diameter of 16.5 mm and a length of 260 mm and a core metal formed of stainless (outer diameter: 5 mm, length: 270 mm) by an upper core member and a lower core member is prepared. The lower core member is provided with an injection hole through which a foaming material is injected into the roller molding mold. A premix polyol and polyisocyanate which are compounded are put in a tank of a casting machine, and are stirred and mixed in the casting machine. Then, a polyurethane foaming material for forming an inner layer of a foamed elastic layer is put in a foaming material receiving portion. Further, in a similar procedure, a polyurethane foaming material for forming a surface layer of the foamed elastic layer is put in the foaming material receiving portion, so that the two kinds of polyurethane foaming materials are separation-disposed in upper and lower portions of the foaming material receiving portion. Incidentally, adjustment is made so that the polyurethane foaming material for the surface layer is foamed and subsequently the polyurethane foaming material for the inner layer is foamed. The above-described foaming material receiving portion is connected to the lower core member, and the roller molding mold is heated, so that the foaming is promoted. The foaming material is cured in this metal mold, and thus a foamed elastic roller is prepared.

### (Improper Solid Followability)

As described with reference to FIG. 3, the toner T is fed by the stirring sheet 45b, and is guided into the developing chamber 46a through the development opening 46c. By the supplying voltage applied by the supplying voltage applying portion 49a, the toner T is incorporated in the supplying roller 43 (in the sponge layer 51 thereof). At this time, an amount of the toner T incorporated in the supplying roller 43 is referred to as an incorporation amount. In the case where the incorporation amount is small, in a solid black image, density satisfies a standard for one-full circumference of the developing roller 41, but thereafter, the density does not satisfy the standard, so that an image defect which is called improper solid followability. In the following, in the solid black image, the one-full circumference (a leading end of an image or a recording material with respect to a rotational direction) of the developing roller 41 is referred to as “after white”. Further, after (a trailing end of the image or the recording material) the “after white” is referred to as “after black”.

In the one-full circumference of the developing roller 41, there is a sufficient application amount of the toner, so that only in a leading end portion, the toner is capable of providing a sufficient density. However, after the one-full circumference of the developing roller 41, the density becomes a density depending on a toner amount of the toner supplied from the supplying roller 43, and therefore, when the incorporation amount is small, a sufficient density cannot be ensured.

The incorporation amount depends on the charging property and the flowability of the toner during the image formation. For that reason, as a means for increasing the incorporation amount, there are two means in which the absolute value of the supplying voltage is made further higher than the absolute value of the developing voltage and in which the flowability of the toner in the developing chamber 46a is improved. As regards the former, when this means is continuously executed, energization deterioration is caused to occur and results in poor durability, and therefore, this means cannot be said a good solution. As regards the latter, although the toner flowability varies depending on specific gravity and the agglomeration degree of the toner itself, the toner flowability is largely influenced by an attitude of the process cartridge 120 and circulation of the toner in the developing chamber 46a, and therefore the toner flowability can be improved depending on the constitution.

The developing device 4 shown in FIG. 3 is an attitude such that the toner accommodating chamber 46b is disposed above the developing chamber 46a (so-called a self-weight type), and in a vertical direction Dr, the development opening 46c is positioned below the stirring shaft 45a and a center (rotation shaft) of the supplying roller 43 is positioned below the development opening 46c. In this system, even when drive of the image forming apparatus 100 is started and drive of the stirring sheet 45b is stopped, the toner T transferred to the developing chamber 46a is not returned to the toner accommodating chamber 46b even when drive of the stirring sheet 45b is stopped, but is moved in the gravitation direction (vertical direction Dr), i.e., remains in the developing chamber 46a as it is. In this situation, when the stirring sheet 45b is further rotated, the toner T in the developing chamber 46a with the self-weight thereof, so that clogging of the toner T occurs and thus circulation of the toner T is inhibited. At this time, the toner T strikes against a wall surface and gathers at a central portion so as to be pressed toward a central portion side. Then, the toner T gathered from opposite wall surfaces passes through the development opening 46c, so that powder pressure of the toner T is largely exerted on a midpoint portion of the supplying roller 43.

In this state, the toner T cannot be satisfactorily incorporated in the supplying roller 43, so that the incorporation amount becomes small. Further, even after the toner T is discharged to the developing roller 41 by a potential difference between the supplying voltage and the developing voltage, the toner T which should be subsequently supplied is not satisfactorily supplied. This phenomenon is more liable to occur after black than after white, so that the incorporation amount is liable to become smaller. For this reason, the improper solid followability is caused. For this reason, in the solid black image required that the toner on the developing roller 41 is all discharged to the photosensitive drum 1, in the developing device 4 of the self-weight type, conspicuous improper solid followability appears at a central portion with respect to the longitudinal direction particularly after black.

In order to solve this improper solid followability, as a method of improving the flowability of the toner besides the method in which the toner itself is adjusted, there is a method in which the incorporation amount of the toner inside the supplying roller 43 is increased by increasing the air permeation amount of the supplying roller 43. Part (a) of FIG. 5 is a graph in which the abscissa represents an air permeation amount [L/min] of the supplying roller 43 in this embodiment, and the ordinate represents an incorporation amount [g] incorporated after black. As shown in part (a) of FIG. 5, it is understood that there is a correlation between the air permeation amount and the incorporation amount of the supplying roller 43 after black. Specifically, the incorporation amount increases with an increasing air permeation amount. In this embodiment, when the incorporation amount of the toner by the supplying roller 43 is not 7 g or more, the improper solid followability occurs.

### (Problem and Solution of Increase in Air Permeation Amount)

Next, a problem due to an increase in air permeation amount of the supplying roller 43 will be described. The increase in air permeation amount leads to enhancement of foaming the sponge, and therefore, a cross-linked structure of the sponge is suppressed, so that the supplying roller 43 itself is in a state in which the supplying roller 43 is soft and is easily deformed. In a state in which the air permeation amount is increased, when the supplying roller 43 is in a high-temperature/high-humidity environment or is left standing for a long time during transportation of the process cartridge 120, in a contact portion between the supplying roller 43 and the developing roller 41, there is a liability that the supplying roller 43 is largely permanent-deformed behind rigidity of the developing roller 41. By the deformed supplying roller 43, a lateral band image defect called supplying roller set occurs in a half-tone image, a solid black image, or the like image is some cases. In an end portion with a fixed end with respect to the longitudinal direction, a contact pressure between the supplying roller 43 and the developing roller 41 is stronger than in a central portion with respect to the longitudinal direction.

Part (b) of FIG. 5 is a graph in which the abscissa represents the air permeation amount [L/min] of the supplying roller 43 in this embodiment, and the ordinate represents a deformation amount [mm] of the supplying roller 43 after standing in a severe environment. Incidentally, the severe environment is the above-described high-temperature/high-humidity environment or the like environment. The graph of part (b) of FIG. 5 shows a relationship between the air permeation amount and the deformation amount of the supplying roller 43 after the supplying roller 43 is left standing for 3 days in a severe environment of a high temperature of 50° C. and a high humidity of 60% RH. As shown in part (b) of FIG. 5, when the air permeation amount increases, the deformation amount becomes large. In this embodiment, when the deformation amount exceeds 0.2 mm, the lateral band becomes risible and leads to the image defect (becomes an NG level).

Therefore, in this embodiment, in order to solve both of the improper solid followability to be eliminated by increasing the air permeation amount and the supplying roller set generated by increasing the air permeation amount, i.e., in order to prevent the supplying roller set from generating while suppressing the improper solid followability, the following method is executed. That is, in this embodiment, there image defects are eliminated by changing the air permeation amount between the end portions and the central portion with respect to the longitudinal direction of the supplying roller 43. As described above, the improper solid followability becomes a problem in the central portion with respect to the longitudinal direction of the supplying roller 43 and the supplying roller set becomes a problem in the end portions with respect to the longitudinal direction of the supplying roller 43. For this reason, in the central portion of the supplying roller 43 with respect to the longitudinal direction, the air permeation amount is increased to a level at which the improper solid followability does not occur, and in opposite end portions, the air permeation amount is decreased to a level at which the supplying roller set does not occur, whereby the above-described problems can be compatibly solved.

### (Method of Changing Air Permeation Amount in Longitudinal Direction)

### (Method 1)

As regards a method of changing the air permeation amount between the central portion and the opposite end portions of the supplying roller 43 with respect to the longitudinal direction, two methods will be described. A first method (method 1) is such that sponge layers 51 different in air permeation amount are bonded to each other as shown in parts (a), (b), and (c) of FIG. 6. Parts (a), (b), and (c) of FIG. 6 show method 1 in which the air permeation amount in this embodiment is changed with respect to the longitudinal direction. As shown in part (a) of FIG. 6, first, two kinds of supplying rollers different in air permeation amount with an air permeation amount A (second air permeation amount) and an air permeation amount B (first air permeation amount) are prepared. Incidentally, the air permeation amount A is lower than the air permeation amount B (A<B).

As shown in part (b) of FIG. 6, in the supplying roller 43, on a portion of a bar-like core metal (shaft body 52), an adhesive which is a primer is undercoated, and then, the supplying roller with the high air permeation amount B and the supplying roller with the low air permeation amount A are inserted. In the following, the supplying roller with the air permeation amount B is referred to as a supplying roller 51A (first supplying roller), and the supplying roller with the air permeation amount A is referred to as a supplying roller 51b (second supplying roller). The supplying roller 51B is disposed in a central portion of the bar-like core metal with respect to a longitudinal direction of the core metal, and the supplying roller 51A is disposed close to each of opposite end portions of the supplying roller 51B, i.e., is disposed in each of opposite end portions of the core metal with respect to the longitudinal direction of the core metal.

As shown in part (c) of FIG. 6, the supplying rollers 51A and 51B are bonded to each other with respect to the longitudinal direction (broken lines a portions). Thus, by using the method of part (a), (b), and (c) of FIG. 6, it is possible to prepare the supplying roller 43 different in air permeation amount with respect to the longitudinal direction.

### (Method 2)

The other method (method 2) is a method in which a completed supplying roller is subjected to a crushing step and thus the air permeation amount is gradually changed. In FIG. 7, the method 2 in which the air permeation amount is changed with respect to the longitudinal direction is shown. FIG. 7 is a schematic view of a crushing portion of a crushing device used in the crushing step. The crushing step is the following step. That is, a supplying roller is sandwiched between two metal drums 1000 and 1001, and air is blown against a sponge surface by an air nozzle 90 while applying a pressure to a foamed sponge layer. By this, a surface layer of the supplying roller is broken, so that cells are communicated with each other to an inside of the sponge layer. The crushing step is performed, as a performance of the supplying roller 43, for stabilizing hardness and the air permeation amount of the supplying roller 43. An air nozzle 90 having a diameter which is from 1/10 to ¼ of a diameter of the supplying roller 43 is positioned with a distance of 5 mm to 30 mm from the surface of the supplying roller 43. To the supplying roller 43 rotating at a speed of 1 rpm to 300 rpm, while moving the air nozzle 90 in an axial direction Da relative to the supplying roller, high-pressure air from 0.2 MP to 1.0 MP is blown against the surface of the supplying roller 43 from a substantially vertical direction.

At this time, by changing a blowing speed of the air nozzle 90 or a rotational speed of the supplying roller 43 itself depending on a position with respect to the longitudinal direction, a communication degree of the cells in the longitudinal direction can be changed. For example, under a condition such that a moving speed of the air nozzle 90 in the longitudinal direction is kept constant, when the rotational speed of the supplying roller 43 is increased to 300 rpm which is a high speed, an amount of the air entering the supplying roller 43 decreases, so that the air permeation amount does not readily increase. On the other hand, when the rotational speed of the supplying roller 43 is decreased to 1 rpm which is a low speed, the amount sufficiently enters the supplying roller 43, and therefore, the air permeation amount readily increases. In addition, the air permeation amount can be controlled by slowing the moving speed of the air nozzle 90 in the longitudinal direction only in the central portion than in the opposite end portions while keeping the number of rotations of the supplying roller 43 at 100 rpm. In this crushing step, the air permeation amount of the supplying roller 43 can be continuously changed.

(Range in which Air Permeation Amount is Changed with Respect to Longitudinal Direction)

The air permeation amount of the supplying roller 43 such that both the problems of the improper solid followability and the supplying roller set are solved will be considered. In this embodiment, in order to prevent the improper solid followability to occurring, as described with reference to part (a) of FIG. 5, the incorporation amount of the supplying roller 43 is 7.0 g or more, and the air permeation amount at this time is 2.5 L/min or more. Further, in this embodiment, in order to prevent the supplying roller set from occurring, as described with reference to part (b) of FIG. 5, the deformation amount is 0.2 mm or less, and the air permeation amount at this time is 2.0 L/min or less.

A minimum air permeation amount in which the supplying roller 43 is capable of suction and discharge of the toner is 0.5 L/min or more and less than 4.5 L/min. Therefore, it is desirable that the air permeation amount in the central portion is made 2.5 L/min or more and 4.5 L/min in order to prevent the improper solid followability from occurring and that the air permeation amount in each of the opposite end portions is made 0.5 L/min or more and less than 2.0 L/min in order to prevent the supplying roller set from occurring. Further, a ratio between the air permeation amount in the central portion and the air permeation amount in each end portion may desirably be 1.25 or more and less than 9.0. When the air permeation amount in the central portion with respect to the longitudinal direction becomes 4.5 L/min or more, even in the central portion, the supplying roller set becomes problematic. Further, when the air permeation amount in each end portion with respect to the longitudinal direction becomes less than 0.5 L/min, the toner cannot be sufficiently incorporated in the supplying roller 43, so that the function as the supplying roller 43 cannot be exhibited.

As regards a position where the air permeation amount is measured, measurement was made in a midpoint with respect to the longitudinal direction for the central portion and in a position of 1/10 of a length from each of opposite ends with respect to the longitudinal direction toward the midpoint for each end portion. The above-described ranges may only be required to be satisfied on the basis of the air permeation amounts measured in the respective positions. In the following embodiments, details and effects will be described.

Contents of an experiment conducted for demonstrating the effects of the embodiments, each of supplying rollers 43 used in the embodiments different in air permeation amount between the central portion and each end portion and a plurality of supplying rollers shown as comparison examples in a table 1 below was assembled in the process cartridge 120 shows in FIG. 2 and was stored for 3 days in the severe environment of the temperature of 50° C. and the humidity of 60% RH. Thereafter, 600 g of the toner was charged, and a solid black image and a half-tone image were printed in an environment of 22.5° C. in temperature and 40% RH in humidity, followed by evaluation of the improper solid followability and the supplying roller set. The half-tone image in the experiment is an image pattern of 0.6 in density as measured by an X-rite densitometer.

TABLE 1

| | CPAPA*¹ [L/min] | EPAPA*² [L/min] |
|---|---|---|
| EMB. 1 | 3.5 | 1.8 |
| EMB. 2 | 2.5 | 1.0 |
| EMB. 3 | 4.0 | 1.2 |
| EMB. 4 | 3.0 | 1.9 |
| Comp. Ex. 1 | 1.8 | 0.5 |
| Comp. Ex. 2 | 4.5 | 3.0 |
| Comp. Ex. 3 | 1.8 | 3.0 |
| Comp. Ex. 4 | 1.0 | 1.8 |
| Comp. Ex. 5 | 3.0 | 4.5 |
| Comp. Ex. 6 | 1.2 | 1.2 |
| Comp. Ex. 7 | 2.0 | 2.0 |
| Comp. Ex. 8 | 2.5 | 2.5 |
| Comp. Ex. 9 | 2.5 | 0.3 |
| Comp. Ex. 10 | 5.0 | 2.0 |

*¹“CPAPA” is the central portion air permeation amount.
*²“EPAPA” is the end portion air permeation amount.

In the table 1, a first column represents embodiments 1 to 4 and comparison examples 1 to 10, a second column represents the air permeation amount [L/min] in the central portion of the supplying roller 43 with respect to the longitudinal direction in each of the embodiments 1 to 4 and the comparison examples 1 to 10, and a third column represents the air permeation amount [L/min] in each end portion of the supplying roller 43 with respect to the longitudinal direction in each of the embodiments 1 to 4 and the comparison examples 1 to 10.

The embodiments 1 to 4 satisfy each of a condition such that the central portion air permeation amount is 2.5 L/min or more and 4.5 L/min or less and a condition such that the end portion air permeation amount is 0.5 L/min or more and 2.0 L/min or less. On the other hand, the comparison examples 1 to 10 are examples which do not satisfy the condition such that the central portion air permeation amount is 2.5 L/min or more and 4.5 L/min or less and/or the condition such that the end portion air permeation amount is 0.5 L/min or more and 2.0 L/min or less.

As regards evaluation of the improper solid followability, a density of an image enter at each of an output leading end and an output trailing end with respect to the longitudinal direction was measured by the X-Rite densitometer, and a ratio of the trailing end density to the leading end density was measured. The resultant values were classified into the following ranks A to C which are evaluation criteria. Similarly, also for each of image opposite end portions with respect to the longitudinal direction, the rank classification was made. Incidentally, the image forming apparatus aims at satisfying the rank B or more.

A: density in leading end center is 1.35 or more, and density ratio is 0.91 or more.

B: density in leading end center is 1.35 or more, and density ratio of 0.71 or more and less than 0.91.

C: density in leading end center is 1.35 or more and density ratio is less than 0.71.

As regards evaluation of the supplying roller set, a density difference between a peripheral portion and appearing on a half-tone image in a position of 2/10 of a full length of the image from either one of image opposite ends with respect to the longitudinal direction at an interval corresponding to a length of one-full circumference of the supplying roller 43 or the developing roller 41 was measured. The resultant values of the density differences were classified into the following ranks A to C which are evaluation criteria. Similarly, also for each of image opposite end portions with respect to the longitudinal direction, the rank classification was made. Incidentally, the image forming apparatus aims at satisfying the rank B or more.

A: lateral band cannot be observed.

B: lateral band can be slightly observed, but density difference is less than 0.1.

C: lateral band can be observed and density difference is 0.1 or more.

In a table 2 shown below, image ranks after printing in the respective embodiments 1 to 4 and the comparison examples 1 to 10 are summarized. Further, part (a) of FIG. 8 is a graph showing a relationship between the air permeation amount and a ratio (density ratio) of the trailing end density to the leading end density in each of the central portion and the end portion of the supplying roller with respect to the longitudinal direction. In part (a) of FIG. 8, the abscissa represents the air permeation amount [L/min], and the ordinate represents the ratio (density ratio) of the trailing end density to the leading end density. Further, part (b) of FIG. 8 is a graph showing a relationship between the air permeation amount and the deformation amount in each of the central portion and the end portion of the supplying roller with respect to the longitudinal direction. In part (b) of FIG. 8, the abscissa represents the air permeation amount [L/min], and the ordinate represents the deformation amount [mm]. In each of parts (a) and 8b) of FIG. 8, the result in the central portion is indicated by a solid line, and the result in the end portion is indicated by a broken line.

TABLE 2

| | EPISF*¹ | CPISF*² | EPSRS*³ | CPSRS*⁴ |
|---|---|---|---|---|
| EMB. 1 | B | A | B | B |
| EMB. 2 | B | B | A | A |
| EMB. 3 | B | A | A | B |
| EMB. 4 | B | B | B | A |
| Comp. Ex. 1 | B | C | A | A |
| Comp. Ex. 2 | A | A | C | B |
| Comp. Ex. 3 | A | C | C | A |
| Comp. Ex. 4 | B | C | B | A |
| Comp. Ex. 5 | A | A | C | A |
| Comp. Ex. 6 | B | C | A | A |
| Comp. Ex. 7 | B | C | B | A |
| Comp. Ex. 8 | A | B | C | A |
| Comp. Ex. 9 | C | B | A | A |
| Comp. Ex. 10 | B | A | B | C |

*¹“EPISF” is the end portion improper solid followability.
*²“CPISF” is the central portion improper solid followability.

In the table 2, a first column represents the embodiments 1 to 4 and the comparison examples 1 to 10. A second column represents the improper solid followability (end portion improper solid followability) in the end portion of the supplying roller 43 with respect to the longitudinal direction, and a third column represents the improper solid followability (central portion improper solid followability) in the central portion of the supplying roller 43 with respect to the longitudinal direction. A fourth column represents the supplying roller set (end portion supplying roller set) in the end portion of the supplying roller 43 with respect to the longitudinal direction, and a fifth column represents the supplying roller set (central portion supplying roller set) in the central portion of the supplying roller 43 with respect to the longitudinal direction.

In the result of the table 2, the end portion improper solid followability was classified into a rank A of 2.5 L/min or more in air permeation amount, a rank B of 0.5 L/min and less than 2.5 L/min in air permeation amount, and a rank C of less than 0.5 L/min in air permeation amount. Further, the central portion improper solid followability was classified into a rank A of more than 3.0 L/min in air permeation amount, a rank B of 2.5 L/min and 3.0 L/min or less in air permeation amount, and a rank C of less than 2.5 L/min in air permeation amount.

As shown in the graph of part (a) of FIG. 8, air permeation amount ranges providing the rank C are different between the end portion and the central portion of the supplying roller 43. Specifically, from the result of FIG. 2, the air permeation amount providing the rank C is less than 0.5 L/min in the end portion and is less than 2.5 L/min in the central portion. A toner powder pressure is applied to the central portion more than the end portion, and the flowability lowers, and therefore, in the central portion, the air permeation amount range providing the rank C of the improper solid followability is wider than that in the end portion. In the comparison examples 1, 3, 4, 6, and 7, the air permeation amounts in the central portion are less than 2.5 L/min, so that the rank of the improper solid followability was the rank C. Further, in the comparison example 9, the air permeation amount in the end portion was less than 0.5 L/min, and the supplying roller 43 could not discharge the toner normally, so that the incorporation amount becomes small. Even in the end portion, the improper solid followability resulted in the rank C.

As regards the supplying roller set, a rank thereof was classified into a rank A of less than 1.5 L/min in air permeation amount, a rank B of 1.5 L/min or more and 2.0 L/min or less in air permeation amount, and a rank C of more than 2.0 L/min in air permeation amount in the end portion (end portion supplying roller set). Further, the rank of the supplying roller set was classified into a rank A of less than 3.5 L/min in air permeation amount, a rank B of 3.5 L/min or more and 4.5 L/min in air permeation amount, and a rank C of more than 4.5 L/min in air permeation amount.

As shown in the graph of part (b) of FIG. 8, air permeation amount ranges providing the rank C, in which the deformation amount exceeds 0.2 mm, are different between the end portion and the central portion of the supplying roller 43. Specifically, the air permeation amount providing the rank C is more than 2.0 L/min in the end portion and is more than 4.5 L/min in the central portion. A fixed end shaft is closer to the end portion than to the central portion, and therefore the deformation amount is large, so that the range of the air permeation amount providing the rank C for the supplying roller set is wide. From part (b) of FIG. 8 and the table 2, it is understood that the air permeation amount corresponds to the rank A when the deformation amount is 0.17 mm or less, corresponds to the rank B when the deformation amount is 0.18 mm or more and 0.20 mm or less, and corresponds to the rank C when the deformation amount is more than 0.2 mm.

In the comparison examples 2, 3, 5, and 8, the end portion air permeation amount exceeds 2.0 L/min, and thus the deformation amount is increased to become more than 2.0 mm, so that evaluation of the supplying roller set became the rank C. Further, in the comparison example 10, the central portion air permeation amount is 4.5 L/min, and thus the voids of the sponge layer increase and therefore the deformation amount exceeds 0.2 mm even in the central portion, so that the evaluation of the supplying roller set became the rank C.

From these results, in order to compatibly realize the improper solid followability and the supplying roller set, there is a need that the central portion air permeation amount is 2.5 L/min or more and 4.5 L/min or less and that the end portion air permeation amount is 0.5 L/min or more and 2.0 L/min. Accordingly, in the embodiments 1 to 4, the supplying roller 43 having appropriate air permeation amounts in the central portion and the end portion were used, so that for both of the improper solid followability and the supplying roller set, the evaluation ranks B or more were ensured and thus these problems were capable of being compatibly realized.

Further, an air permeation amount ratio in the central portion to the end portion required for establishing the rank B or more becomes 1.25 or more and 9 or less, and in order to establish the rank A or more for solving at least both of the problems consisting of the central portion improper solid followability and the end portion supplying roller set, the air permeation amount ratio was 2 or more and 9 or less.

As described above, according to this embodiment, even in a state in which the air permeation amount of the supplying roller is increased, it is possible to reduce the occurrence of the image defect.

### <End Portion Toner Scattering>

By controlling the air permeation amount of the supplying roller 43 with respect to the longitudinal direction, it is possible to suppress the image defects of both of the improper toner followability (improper solid followability) remarkably occurring in the image central portion and the supplying roller set remarkably occurring in the end portion. However, when the supplying roller 43 is continuously used, particularly in an image end portion region and in a range in which the supplying roller set is suppressed by setting the air permeation amount of the supplying roller 43 low, toner circulation in the developing chamber 46a becomes poor, so that toner deterioration is promoted.

FIG. 11 is a schematic view for illustrating end portion toner scattering and showing an end portion with respect to the longitudinal direction. In the end portion region in which the toner deterioration, the toner is sandwiched at a toner regulating portion in a contact portion between the developing roller 41 and the developing blade 42. By the influence of friction with the developing roller 41 and heat, toner particles melt together and are fused on the surface of the developing blade 42. Here, a portion where toner fusion (melt-sticking) occurs on the surface of the developing blade 42 is referred to as a fused portion A. When the toner fusion on the surface of the developing blade 42 starts to occur, the toner supplied from the supplying roller 43 to the developing roller 41 is gradually accumulated in the fused portion A and is similarly fused, so that a fused matter of the toner grows. When a height of the fused matter in the fused portion A becomes 100 to 150 μm or more, a gap is generated between the developing blade 42 and the developing roller 41, so that the toner is blown in an arrow B direction (see also a broken arrow B in FIG. 1). Further, when the fused matter is formed on the developing blade 42, and thus toner coat on the developing roller 41 cannot be uniformly formed in the longitudinal direction, so that a thickness of the toner coat on the developing roller 41 causes non-uniformity. By this, due to a centrifugal force by rotation of the developing roller 41, the toner scattered by being peeled off from the toner coat generates. That is, the toner scattered by being leaked from the gap between the developing roller 41 and the developing blade 42 and the toner scattered by being peeled off from the developing roller generated due to the fused matter on the developing blade 42. Incidentally, in FIGS. 1 and 11, the arrow B direction is shown as one direction, but in actuality, the toner is not always scattered only in a fixed direction.

The toner blown in the arrow B direction is scattered depending on rotation of the developing roller 41, and therefore, every time when an image forming operation is executed and the recording material P is fed, toner scattering occurs on the developing blade 42 and in the neighborhood of an end portion of the developing container. Further, when the feeding of the recording material P is continued, the toner scattering is advanced to an inside of the apparatus main assembly 110, so that there is a liability that the inside of the apparatus main assembly 110 and the fed recording material P are contaminated with the scattering toner.

### <Suppressing Control Flow of Toner Scattering>

In FIG. 12, a flowchart of suppressing control of the toner scattering in the embodiment 1 will be described. By using this flowchart, control for suppressing fusion of the toner to the surface of the developing blade 42 will be described. In a step (hereinafter, abbreviated as “S”) 101, when the controller 200 receives print start signal, the controller 200 starts image formation. Incidentally, the controller 200 receives, in addition to the print start signal, various pieces of information during execution of printing, such as information, for example, the number of printed sheets.

In S102, the controller 200 discriminates whether or not the operation is a continuous printing operation, on the basis of the information on the number of printed sheets. In the case where the controller 200 discriminated in S102 that the operation is the continuous printing operation, the controller 200 causes processing to go to S103. In S103, the controller 200 executes a sheet interval sequence, so that toner discharge in an end portion (development end portion) of the developing roller 41 with respect to the longitudinal direction is executed. Here, the sheet interval refers to an interval between a trailing end of a recording material (present paper) (or present toner image) subjected to the image formation and a leading end of a recording material P (subsequent paper) (or subsequent toner image) subjected to the image formation subsequently to the present image formation in the continuous printing.

In the sheet interval, the controller 200 causes the exposure device 3 to irradiate the surface of the photosensitive drum 1 with laser light only in a region corresponding to opposite end portions of the developing roller 41, so that a potential of the surface of the photosensitive drum 1 is changed to a dark portion potential (VL). The controller 200 develops a portion (VL portion), of the surface of the photosensitive drum 1, irradiated with the laser light is developed with toner supplied from the developing roller 41. This operation is referred to as the toner discharge in the development end portion. Even when the toner discharge in the development end portion is executed, the toner discharge is executed in the sheet interval, and therefore, there is no or a small influence thereof on the image to be formed on the recording material P.

In S104, the controller 200 discriminates whether or not the printing operation is ended, and in the case where the controller discriminated that a predetermined printing operation is not ended, the controller 200 returns the processing to S103, in which the toner discharge in the development end portion is executed in the sheet interval during the continuous printing. In the case where the controller 200 discriminated in S104 that the printing operation is ended, the controller 200 causes the processing to go to S105.

In S105, the controller 200 executes a post-rotation sequence, in which the toner discharge in the development end portion is executed similarly as in the operation of S103, and then ends the processing. In the case where the controller 200 discriminated in S102 that the operation is not the continuous printing, the controller 200 causes the processing to go to S105. Incidentally, the post-rotation sequence is an operation including an operation executed after the image forming operation is ended, for example after a stop of high-voltage application or after an end of temperature control of the fixing provided, and including a separation operation between the developing roller 41 and the photosensitive drum 1, and the like operation. Even when the toner discharge in the development end portion is executed, the toner discharge is executed after the end of the printing operation, and therefore, there is no or small influence thereof on the image to be formed on the recording material P. Incidentally, after the toner discharge is executed, the developing roller 41 and the photosensitive drum 1 are put in a separation state. In the embodiment 1, every printing operation, the toner discharge in the development end portion is executed in the sheet interval sequence or the post-rotation sequence.

In the following embodiment, details and effects will be described.

### <Evaluation Experiment>

Content of an experiment conducted for demonstrating an effect of the embodiment 1 will be described. A supplying roller 43 used in this embodiment and different in air permeation amount between the central portion and the end portion is shown in a table 3 appearing hereinafter. A process cartridge 120 to which the supplying roller 43 is mounted is prepared. Thereafter, 460 g of toner of 1.45 g/cm³ in specific gravity is charged, followed by durability evaluation of toner scattering in a low temperature/low humidity (15° C./10% RH) environment. A process speed is set to 280 mm/sec, and recording materials P on which lateral-line images each with a print ratio of 2% are formed, are continuously fed, and evaluation was performed until the images were printed on 30,000 sheets of recording materials P.

Every 10,000 sheets, end portion contamination of the recording material P on which the image was printed and a toner scattering state in the photosensitive drum 4 and the apparatus main assembly 110 after the process cartridge 120 is removed from the apparatus main assembly 110, were checked and evaluated. Incidentally, the end portion of the recording material P refers to an end portion which corresponds to the end portion of the developing roller 41 with respect to the longitudinal direction and which extends along a direction (also a main scan direction) perpendicular to the feeding direction. A region and a width of the toner used for development of the electrostatic latent image on the photosensitive drum 1 were as follows. The region was a region in which the air permeation amount of the supplying roller 43 in each of the opposite end portions was 1.8 L/min. Incidentally, the width is a length of the supplying roller 43 in the longitudinal direction. On the photosensitive drum 1, the electrostatic latent image is developed into a solid black image corresponding to one-full circumference of the developing roller 41 in a 30 mm-width from each of opposite ends of the supplying roller 43. Further, the photosensitive drum 1 is exposed to light to an end portion mask region of the exposure device 3, i.e., an exposure enable region with respect to the main scan direction, so that the electrostatic latent image was developed with the toner. In normal image formation, from viewpoints of a writing position of the laser light with respect to the main scan direction and stability of a light amount, the end portion mask region of the end portion device 3 is designated. However, the sheet interval sequence and the post-rotation sequence are executed during non-image formation, i.e., during a period in which the image is not formed on the recording material P, and aim at that the toner is transferred and discharged to a far end portion region in the developing chamber 46a from a condition such that printing is made during the non-image formation. For this reason, there is no need that a point to be considered during the normal image formation is considered during the non-image formation.

TABLE 3

| | CPAPA*¹ [L/min] | EPAPA*² [L/min] |
|---|---|---|
| EMB. 1 | 3.5 | 1.8 |

*¹“CPAPA” is the central portion air permeation amount.
*²“EPAPA” is the end portion air permeation amount.

In the table 3, the central portion air permeation amount (3.5 [L/min]) and the end portion air permeation amount (1.8 [L/min]) of the supplying roller 43 in the embodiment 1 are shown.

Evaluation of the toner scattering was made according to the following evaluation criteria by performing classification of rank into the following ranks (levels) A, B, and C in terms of toner scattering to the process cartridge 120 and the developing container, toner contamination into the main assembly of the image forming apparatus 100, and whether or not toner contamination occurs on an evaluation recording material subjected to sheet passing.

A: Toner scattering is not observed (no toner scattering).

B: Toner scattering can be slightly observed (slight scattering of toner to the process cartridge and the developing container).

C: Toner scattering can be observed (toner contamination into the image forming apparatus main assembly and toner contamination on the evaluation recording material.

In a table 4 below, image levels in each of examples after the printing are summarized. As a comparison example, a process cartridge and a developing device were prepared in the same condition as the condition in the embodiment 1, and in a constitution in which toner scattering suppressing processing (toner discharge in development end portion) as shown in FIG. 21 (hereinafter, this toner scattering suppressing processing is referred to as toner development sequence), an evaluation experiment was conducted in the same condition as the condition in the embodiment 1.

TABLE 4

| | 10000 SHEETS | 20000 SHEETS | 30000 SHEETS |
|---|---|---|---|
| COMP. EX. | A | B | C |
| EMB. 1 | A | A | A |

As regards a result of the table 4, in the case of the comparison example, up to 10,000 sheets, there was no toner scattering and the image level was a level A, but at 20,000 sheets, the toner scattering to the developing container was confirmed, so that the image level became a level B. At 30,000 sheets, the toner contamination into the image forming apparatus and the toner contamination on the evaluation recording material were confirmed, so that the image level was a level C.

On the other hand, in the embodiment 1, the toner development sequence was executed every sheet passing operation in the end portion region of the supplying roller 46, so that in either one of the number of sheets (10,000 sheets, 20,000 sheets, and 30,000 sheets), the toner scattering (contamination) was capable of being suppressed, so that the image level was the level A. This is an effect that toner deteriorated in the end portion region of the developing chamber 46a was forcedly subjected to development (discharged) by executing the toner development sequence. The deteriorated toner is appropriately subjected to development on the photosensitive drum 1, so that function of the toner on the surface of the developing blade 42 is suppressed.

In the embodiment 1, description was made in the development separation constitution in which the developing device 4 and the photosensitive drum 1 are in contact with each other only during the image formation executed by drive of a motor and in which the electrostatic latent image is developed on the photosensitive drum 1 with the toner, but the present invention is not limited thereto. The embodiment 1 is also effective even in a constitution in which the developing device 4 and the photosensitive drum 1 are always in contact with each other. Particularly, in the constitution in which the developing device 4 is always contacted to the photosensitive drum 1, a contact and separation operation performed every print job in the development separation constitution does not occur. As a result, the toner in the developing chamber 46a is not loosened by the contact and separation operation and vibration of the developing container, so that localization and a circulating property of the toner between the developing chamber 46a and the toner accommodating chamber 46b are not satisfactory, so that there is a tendency that the toner deterioration is more promoted. The embodiment 1 is effective even in a constitution which is not the development separation constitution.

As described above, according to the embodiment 1, fusion of the toner to the developing blade is suppressed, so that the toner scattering into the image forming apparatus main assembly can be suppressed.

### Embodiment 2

In the embodiment 1, during the sheet interval sequence and the post-rotation sequence in the print job, the toner was continuously supplied (subjected to development) in the end portion region with respect to the longitudinal direction. By this, the toner to be stagnated and fused in the fused portion A between the developing blade 42 and the developing roller 41 was discharged to the photosensitive drum 1, so that the fusion of the toner to the developing blade 42 was suppressed. Here, there is a liability that supply of the toner in the sheet interval and post-rotation sequences in each job leads to an increase in amount of the toner which does not contribute to the image formation. Accordingly, in the embodiment 2, the toner development sequence is executed at a timing depending on the number of rotations of the developing roller 41 and the number of printed sheets, so that the increase in amount of the toner which does not contribute to the image formation is suppressed.

### Control of Embodiment 2

In FIG. 13, a flowchart of control for suppressing toner scattering in the embodiment 2 is shown. By using this flowchart, control for suppressing fusion of the toner to the surface of the developing blade 42 will be described. In the case where the embodiment 2 overlaps with the embodiment 1, description thereof will be omitted. In the following description, the toner development sequence in the embodiment 2 is also referred to as a periodical sequence. Further, the controller 200 includes a counter, and the number of printed sheets is managed with the counter.

In S201, the controller 200 receives a print start signal and starts image formation. In S202, the controller 200 makes reference to the counter and discriminates whether or not a total number of printed sheets after the last executed periodical sequence becomes X sheets or more. Here, X sheets as a predetermined number of sheets is a threshold for discriminating whether or not the periodical sequence should be executed and will be described. In the case where the controller 200 discriminated in S202 that the number of printed sheets is X sheets or more, the controller 200 causes the processing to go to S203.

In S203, the controller 200 executes the periodical sequence and thus executes toner discharge in an end portion (development end portion) with respect to the longitudinal direction. Incidentally, in the periodical sequence of the embodiment 2, a solid black image corresponding to 3-full circumferences of the developing roller 41 with a width of 30 mm from each of opposite ends of the supplying roller 43 is formed on the photosensitive drum 1 in each of opposite end portion regions of the supplying roller 43 in which the periodical sequence is executed in the embodiment 1 and in which the air permeation amount is 1.8 L/min.

In S204, the controller initializes the counter for counting the number of printed sheets to 0 in order to use a value of the counter in discrimination as to whether or not a subsequent periodical sequence should be executed. The value of the counter is realized by writing information in the RAM 203 of the image forming apparatus 100 or in the non-volatile memory 127 mounted to the process cartridge 120 and the developing device 4.

In S205, the controller 200 discriminates whether or not the printing operation is ended, and in the case where the controller discriminates in S205 that the printing operation is ended, the controller 200 ends the print job in S206 and ends the processing. In the case where the controller 200 discriminated in S205 that the printing operation is not ended, the controller 200 causes the processing to return to S202 and continues the image forming operation. In the case where the controller 200 discriminated in S202 that the number of printed sheets is less than X sheets from the last periodical sequence, the controller 200 causes the processing to go to S205. In this case, the periodical sequence is not executed.

### <Evaluation Experiment>

In the following embodiments, details and effects will be described.

Contents of an experiment conducted for demonstrating an effect of the embodiment 2 will be described. A condition of an evaluation experiment, a discrimination criteria, a comparison example, and the like overlap with those in the embodiment 1, and therefore description will be omitted.

In the embodiment 2, some conditions were set for the threshold of X sheets used in discrimination in S202 of FIG. 13, and then the evaluation experiment was conducted. An embodiment in which the threshold is X=50 sheets in the case where A4 sheets are fed (short edge feeding) is an embodiment 2-1, and an embodiment in which the threshold is X=100 sheets is an embodiment 2-2. In a table 5, image levels after printing in each of the embodiments 2-1 and 2-2, and the comparison example are summarized.

TABLE 5

| | 10000 SHEETS | 20000 SHEETS | 30000 SHEETS |
|---|---|---|---|
| COMP. EX. | A | B | C |
| EMB. 2-1 | A | A | A |
| EMB. 2-2 | A | A | B |

In the table 5, evaluation results for the number of print sheets of 10,000 sheets (second column), 20,000 sheets (third column), and 30,000 sheets (fourth column) are shown.

The result of the table 5 will be described. The comparison example is the same as the embodiment 1 in condition and evaluation result, and therefore description thereof will be omitted.

In the case where the threshold X is 50 sheets in the embodiment 2-1, a frequency of the periodical sequence is high and the toner discharge control is carried out, and therefore, even when printing of images is continued to 30,000 sheets, the toner scattering was capable of being suppressed. In the case where the threshold X is 100 sheets, up to 20,000 sheets, there is no occurrence of the toner scattering, and even in the case where the printing is continued to 30,000 sheets, the level B required for the image forming apparatus 100 was capable of being satisfied. Accordingly, under the condition of the embodiment 2, the threshold X (sheets) may desirably be set to 100 sheets or less (X≤100). Further, every print job, the sheet interval sequence and post-rotation sequence are not executed, and therefore, it is possible to suppress an increase in use amount of the toner which does not contribute to the image formation.

In the embodiment 2, depending on the number of printed sheets converted to the number of A4-size printed sheets (short edge feeding), the toner development sequence was executed periodically, but an execution condition of the toner development sequence is not limited thereto. For example, the number of rotations of the developing roller 41 is managed by the RAM 203 or the like in the image forming apparatus 100 and a threshold thereof (predetermined number of rotations) is set, and then the toner development sequence may be periodically executed. This is because it is known that the toner deterioration is promoted since the developing device 4 including the developing roller 41 and the supplying roller 43 is rotated and the toner is rubbed with these rotatable members.

As described above, according to the embodiment 2, fusion of the toner to the developing blade is suppressed, so that the toner scattering into the image forming apparatus main assembly can be suppressed.

### Embodiment 3

In the embodiment 2, the toner development sequence was periodically executed depending on the number of printed sheets or the number of rotations of the developing roller 41, not only a toner scattering phenomenon but also an increase in use amount of the toner which does not contribute to the image formation were suppressed. Here, in the case where the toner development sequence is periodically executed depending on the number of printed sheets or the number of rotations of the developing roller 41, the toner development sequence is executed in such a manner that the image forming operation is stopped by causing interruption once during the image formation. For example, in a job in which the number of continuously printed sheets is large, there is a liability that the number of times of execution of the periodical sequence increases and thus a print waiting time increases. Accordingly, in the embodiment 3, the toner development sequence is periodically executed depending on a print ratio of the image to be printed, so that an increase in waiting time is suppressed.

### Control of Embodiment 3

In FIG. 14, a flowchart of control for suppressing toner scattering in the embodiment 3 is shown. By using this flowchart, control for suppressing fusion of the toner to the surface of the developing blade 42 will be described. In the case where the embodiment 3 overlaps with the embodiments 1 and 2, description thereof will be omitted. Further, processes S301 and S303 to S306 of FIG. 14 are similar to the processes S201 and S202 to S205, respectively, of FIG. 13, and therefore, description thereof will be omitted.

In S302, the controller discriminates whether or not an average print ratio stored in the RAM 203 and/or the non-volatile memory 207 is Y % or less. Here, Y % is a threshold for discriminating whether or not the periodical sequence should be executed and is 4%, for example. In the case where the controller 200 discriminated in S302 that the average print ratio is larger than Y % on an A4-size paper conversion basis, the periodical sequence is not executed and the controller 200 causes the processing to go to S307. In the case where the controller 200 discriminated in S302 that the average print ratio is Y % or less, the controller 200 causes the processing to go to S303, and executes the periodical sequence depending on the number of printed sheets in S303 and later. In S306, the controller 200 rewrites (stores) information in the RAM 203 and/or the non-volatile memory 207 to information at the time of an end of the printing operation, and ends the print job and then ends the processing. Incidentally, in the case of “No of S303”, the controller 200 causes the processing to go to S307, and in the case of “No of S306”, the controller 200 causes the processing to S302.

The controller 200 measures a light emission count of the laser light of the exposure device 3 and is capable of detecting an amount of the toner used for printing on the basis of the measured light emission count (hereinafter, this amount is referred to as a toner consumption amount). For example, the controller 200 (CPU 201) is capable of using a toner consumption amount detecting system by dot number counting. The controller 200 counts the number of dots of an image formed on the photosensitive drum 1 (hereinafter, this number of dots is referred to as an image dot number), and estimates a toner consumption amount Xg in the developing container. The controller 200 converts the image dot number to a value corresponding to a toner amount and thus estimates the toner consumption amount Xg of the toner used by the printing (print). For this purpose, there is a need that the controller grasps the toner consumption amount per dot in advance.

In the embodiment 3, a toner consumption amount per dot Xo acquired in an experiment or the like in advance is stored in the non-volatile memory 207 of the process cartridge 120. Incidentally, the toner consumption amount per dot Xo is, for example, 10 ng (Xo=10 ng).

### <Evaluation Experiment>

In the following embodiments, details and effects will be described. Contents of an experiment conducted for demonstrating an effect of the embodiment 3 will be described. A condition of an evaluation experiment, a discrimination criteria, a comparison example, and the like overlap with those in the embodiments 1 and 2, and therefore description will be omitted.

In the embodiment 3, some conditions were set for average print ratio shown in S302 of FIG. 14, and then the evaluation experiment was conducted.

In the case where images are printed on sheets on an A4 paper conversion basis, an embodiment in which the average print ratio is 2% is an embodiment 3-1, an embodiment in which the average print ratio is 5% is embodiment 3-2, and an embodiment in which the average print ratio is 10% is an embodiment 3-3. In a table 6, image levels after printing in each of the embodiments 3-1, 3-2 and 3-3, and the comparison example are summarized.

TABLE 6

| | 10000 SHEETS | 20000 SHEETS | 30000 SHEETS |
|---|---|---|---|
| COMP. EX. | A | B | C |
| EMB. 3-1 | A | A | A |
| EMB. 3-2 | A | B | B |
| EMB. 3-3 | A | A | — |

In the table 6, evaluation results for the number of print sheets of 10,000 sheets (second column), 20,000 sheets (third column), and 30,000 sheets (fourth column) are shown.

In the table 6, the embodiment 3-1 was 2% in average print ratio and Y % (=4%) or less in threshold as a predetermined print ratio, and the threshold at which the periodical stirring is executed was the same setting (X=50 sheets) as that in the embodiment 2-1. As a result, the frequency of the periodical toner development sequence is high, and the toner discharge control is executed, so that it was possible to suppress the toner scattering. In the embodiment 3-2, the average print ratio is 5%, and on the basis of the discrimination of S302 of the flowchart of FIG. 14, the average print ratio (5%) is larger than the threshold Y % (4%), so that the condition in the embodiment 3-2 is a condition under which the periodical toner development sequence is not executed. The toner scattering level became the level B during printing of 20,000 sheets and 30,000 sheets, and thus satisfied the level required for the image forming apparatus 100.

In the embodiment 3-3, the condition was such that the average print ratio was 10% and thus the periodical sequence was not executed, but it was confirmed that the toner scattering level was the level A up to 20,000 sheets. Incidentally, in the case where the average print ratio was 10%, at 25,000 sheets, the timing became a toner supply timing, and therefore, evaluation was ended, but the toner scattering level was the level B at 25,000 sheets, so that a level required for the image forming apparatus 100 was satisfied.

Accordingly, under the condition of the embodiment 3, the threshold of the print ratio of the periodical toner development sequence may desirably be set to 4%. Further, the periodical toner development sequence is not executed depending on the count of the print job, and therefore, for example, as regards a user who executes printing of 5% or more in average print ratio in many cases, it was confirmed that the increase in waiting time was capable of being suppressed.

In the embodiment 3, the periodical toner development sequence was executed depending on the average print ratio on the A4-size paper conversion basis (short edge feeding). The threshold Y % of S302 of FIG. 14 may only be required to be set in the following manner. When the average print ratio is high, the amount of the toner consumed when the image is printed on a single A4-sized paper becomes large correspondingly, and when the toner consumption amount becomes large, a time until the developing device 4 reaches an end of a lifetime thereof becomes short. It is known that toner deterioration is promoted by drive of the developing device 4 including the developing roller 41 and the supplying roller 43. The toner is consumed before the toner deterioration is promoted, and therefore, with a higher print ratio, a possibility that the toner is fused on the surface of the developing blade 42 and the toner scattering occurs lowers. In view of this, an experiment or the like is conducted in advance, and the threshold Y % is set to 4%, for example.

As described above, according to the embodiment 3, the toner fusion onto the developing blade is suppressed, so that it is possible to suppress the toner scattering into the image forming apparatus main assembly.

### Embodiment 4

In the embodiment 3, by executing the periodical toner development sequence depending on the average print ratio of the image, not only the toner scattering phenomenon but also a degree of the interruption during the continuous printing were reduced, so that the waiting time of the user was also capable of being reduced. Here, when the toner development sequence is executed for a sheet narrower in width than A4-size paper (first sized recording material) as the predetermined recording material (hereinafter, this narrower sheet is referred to as small-size paper (second-sized recording material), due to a difference between a developing region of the small-sized paper and a developing region of the A4-sized paper with respect to the longitudinal direction, the image forming apparatus 100 cannot cope with the toner deterioration promotion level, so that the toner scattering occurs in some instances.

Particularly, in a job large in number of continuously printed sheets of the small-paper, the toner in the end portion region with respect to the longitudinal dir sized ection is not consumed during the image formation, and therefore, the toner is repetitively rubbed on the developing roller 41, so that the toner deterioration is promoted than in an operation in a normal printing mode. During printing of the small-sized paper, a region of the small-sized paper fed in the longitudinal direction is shorter than a region of the A4-sized paper, and therefore, the thermal influence by the fixing device 10 is large, so that a temperature rise state of the main assembly of the image forming apparatus 100 becomes severe. As a countermeasure thereagainst, the controller 200 carries out feeding control such that a throughput is lowered by increasing a sheet interval even in the sequence during the image formation.

As a result, particularly, in the end portion with respect to the longitudinal direction, in addition to a state in which the image is not formed, the developing device 4 is continuously driven and rotated while the toner is not consumed, and therefore, the toner deterioration is promoted. Accordingly, in the embodiment 4, the toner development sequence is changed depending on a size of the recording material P subjected to the printing and on an operation in a print mode. Incidentally, the print mode includes a normal sheet passing mode as a first mode in which the recording material P is fed at a normal feeding speed (first feeding speed) and a small-sized sheet passing mode as a second mode in which the recording material P is fed by lowering the throughput as described above (at a second speed). By this, even in the case where the image is printed on the small-sized paper, the toner scattering can be suppressed.

### Control of Embodiment 4

In FIG. 15, a flowchart of control for suppressing toner scattering in the embodiment 4 is shown. By using this flowchart, control for suppressing fusion of the toner to the surface of the developing blade 42 will be described. In the case where the embodiment 2 overlaps with the embodiments 1 to 3, description thereof will be omitted. Further, processes S401 and S405 of FIG. 15 are similar to the processes S201 and S205, respectively, of FIG. 13, and a process S406 of FIG. 15 is similar to the process of S307 of FIG. 14, and therefore, description will be omitted.

In S402, the controller 200 discriminates whether or not the size of the recording material P subjected to the image formation is A4 size. In the case where the controller 200 discriminated in S402 that the size of the recording material P subjected to the image formation is the A4 size, the controller 200 discriminates that the print mode is the small-sized sheet passing mode and causes the processing to go to S407. In S407, the controller 200 executes the toner development sequence described in, for example, the embodiment 1 (FIG. 11), the embodiment 2 (FIG. 12), and the embodiment 3 (FIG. 13).

In the case where the controller 200 discriminated in S402 that the size of the recording material P subjected to the image formation is a size (small size) shorter than the A4 size with respect to the longitudinal direction, the controller 200 causes the processing to go to S403. In S403, the controller 200 discriminates the print mode as the small-sized sheet passing mode and executes a small-size toner development sequence, and thus executes the toner discharge in the non-image printing region. The small-size toner development sequence will be described later. In S404, the controller 200 counts the number of times or the like of execution of the small-size toner development sequence and causes the RAM 203 and/or the non-volatile memory 127 to store the counted number. Incidentally, in the case of “No of S405”, the controller causes the processing to return to S402.

The small-size toner development sequence in S403 was such that in the non-image print region of the recording material P subjected to printing, the electrostatic latent image is developed into a solid black image, on the photosensitive drum 1, corresponding to 2-full circumference of the developing roller 41 during the sheet interval sequence and during the post-rotation sequence. For example, when the size of the recording material P subjected to the printing is A5 size (short edge feeding), the non-image print region is width of 50 mm (>30 mm) from each of opposite end portions of the supplying roller 43. This is because not only the air permeation amount in the opposite end portion regions of the supplying roller 43, but also the operation in the small-size sheet passing mode is executed, so that a region in which the toner is not consumed occurs, and therefore, correspondingly, the toner deterioration is also promoted.

### <Evaluation Experiment>

In the following embodiments, details and effects will be described. Contents of an experiment conducted for demonstrating an effect of the embodiment 4 will be described. A condition of an evaluation experiment, a discrimination criteria, a comparison example, and the like overlap with those in the embodiment 1, and therefore description will be omitted.

In the embodiment 4, some conditions were set in the operation in the small-size sheet passing mode in S403 of FIG. 15, and then the evaluation experiment was conducted. In a low temperature/low humidity (15° C./10% RH) environment, durability evaluation of the toner scattering was performed. The evaluation was made in a manner such that the process speed was set to 280 mm/sec and lateral line images with a print ratio of 2% were continuously formed on A5-size paper up to 15,000 sheets. Further, end portion contamination with respect to a direction (longitudinal direction of the developing blade 42 or the like) perpendicular to the feeding direction of the A4-size paper was evaluated every 5,000 sheets, and in addition, the process cartridge 120 is taken out, and then a toner scattering state in the developing device 4 and the image forming apparatus 100 was checked and evaluated.

As the embodiment 4, the electrostatic latent images were developed into solid black images, on the photosensitive drum 1, corresponding to 2-full circumferences of the developing roller 41 during the sheet interval sequence and during the post-rotation sequence in a region of width of 50 mm from each of opposite ends of the supplying roller 43 with respect to the longitudinal direction. Similar evaluation was performed as a comparison example 1 in an operation in a mode in which the toner development sequence is not executed, and as a comparison example 2 in an operation in a mode similar to the toner development sequence executed with the A4-sized paper.

In a table 7, image levels after printing in each of the embodiment 4, and the comparison examples 1 and 2 are summarized.

TABLE 7

| | 5000 SHEETS | 10000 SHEETS | 15000 SHEETS |
|---|---|---|---|
| COMP. EX. 1 | B | C | C |
| COMP. EX. 2 | A | B | C |
| EMB. 4 | A | A | A |

In the table 7, evaluation results for the number of print sheets of 5,000 sheets (second column), 10,000 sheets (third column), and 15,000 sheets (fourth column) are shown.

In the table 7, as regards the comparison example 1, the periodical toner development sequence is not executed, and therefore, the toner scattering level was the level B at the time of 5,000 sheets, but at 10,000 sheets and later, it was observed that the toner was scattered into the image forming apparatus 100 and the inside of the image forming apparatus 100 is contaminated with the scattering toner, and thus the toner scattering level became the level C. In the comparison example 2, the periodical toner development sequence was executed, but the region in which the electrostatic latent image is developed into the solid toner image in each of opposite end portions with respect to the longitudinal direction is narrow (30 mm width). For that reason, at 10,000 sheets and later, the toner scattering was observed and thus the toner scattering level became the level C. In the embodiment 4, depending on the size of the recording material P subjected to the printing, the developing region of the electrostatic latent image with the toner was extended (50 mm width), so that the toner scattering was capable of being suppressed. Accordingly, under the condition of the embodiment 4, setting may desirably be made so that depending on the size of the recording material P subjected to the printing, the print region with respect to the longitudinal direction in the periodical toner development sequence is extended.

The image forming apparatus 100 of the embodiment 1 is an image forming apparatus in which recording materials P having sheet widths from A4-sized paper to LTR-sized paper are capable of being passed through the fixing device, and description thereof was made using, as an example, a corresponding process cartridge 120 and a corresponding developing device 4, but the present invention is not limited thereto. For example, when the image forming apparatus, the process cartridge, and the developing device which are capable of permitting passing of the recording materials P with sheet widths up to A3-sized paper are used, a width of an image region executed by the corresponding supplying roller 43 and the toner development sequence may desirably be changed.

As described above, according to the embodiment 4, the toner fusion onto the developing blade can be suppressed, so that the toner scattering into the image forming apparatus main assembly can be suppressed.

### OTHER EMBODIMENTS

In the above-described embodiments, in the toner development sequence, development of the electrostatic latent image with toner in each of the opposite end portions with respect to the longitudinal direction is executed, but may also be executed in another region, for example, in a whole region with respect to the longitudinal direction.

Further, in the above-described embodiments, in order to enhance the flowability of the toner in the end portion, the development was executed, but the present invention is not limited thereto. A constitution in which the toner is discharged in the end portion or in another region including the whole region with respect to the longitudinal direction by a means other than the means for developing the electrostatic latent image with the toner may be employed.

The present invention is also capable of being realized by processing such that a program for realizing one or more function of the above-described embodiments is supplied to a system or an apparatus (device) through a network or a storage medium and then one or more processor in a computer of the system or the apparatus reads and executes the program. Further, the present invention is also capable of being realized by a circuit (for example, ASIC) for realizing one or more function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-027522 filed on Feb. 27, 2024 and 2024-027523 filed on Feb. 27, 2024, which are hereby incorporated by reference herein in their entirety.

What is claimed is:

1. A developing device comprising:
a developer carrying member configured to carry a developer and configured to form a developer image by developing an electrostatic latent image with the developer;
a supplying roller configured to supply the developer to the developer carrying member in contact with the developer carrying member;
an accommodating chamber configured to hold the developer;
a developing chamber including the developer carrying member and the supplying roller;
a development opening configured to partition the developing chamber and the accommodating chamber;
a stirring shaft provided in the accommodating chamber; and
a stirring member configured to stir the developer by being rotated about the stirring shaft in the accommodating chamber,
wherein in an attitude in which the developing device is mounted in an image forming apparatus and in which opposite end portions of the supplying roller with respect to a longitudinal direction of the supplying roller are supported by a frame of the image forming apparatus,
the development opening is provided above a rotation axis of the supplying roller,
the stirring shaft is provided above the development opening, and
the supplying roller is larger in absolute value of an air permeation amount in a central portion thereof with respect to the longitudinal direction than in a position of 1/10 of a length thereof from each of the opposite end portions thereof.

2. A developing device according to claim 1, wherein the supplying roller is 2.5 L/min or more and 4.5 L/min or less in absolute value of the air permeation amount in the central portion thereof with respect to the longitudinal direction,
wherein the supplying roller is 0.5 L/min or more and 2 L/min or less in absolute value of the air permeation amount in each of the opposite end portions thereof with respect to the longitudinal direction, and
wherein a ratio of the air permeation amount in the central portion to the air permeation amount in each of the opposite end portions is 1.25 or more and 9 or less.

3. A developing device according to claim 1, wherein the supplying roller is 2 or more and 9 or less in ratio of the air permeation amount in the central portion to the air permeation amount in each of the opposite end portions with respect to the longitudinal direction.

4. A developing device according to claim 1, wherein the supplying roller includes an electroconductive sponge layer.

5. A developing device according to claim 4, wherein the sponge layer includes a cross-linked urethane resin.

6. An image forming apparatus for forming an image on a recording material, comprising:
an image bearing member configured to bear an electrostatic latent image; and
a developing device according to claim 1, configured to develop the electrostatic latent image.

7. A supplying roller for supplying a developer to a developer carrying member in contact with the developer carrying member, comprising:
a central portion with respect to a longitudinal direction; and
opposite end portions with respect to the longitudinal direction,
wherein in an attitude in which the supplying roller is mounted in an image forming apparatus and in which the opposite end portions are supported by a frame of the image forming apparatus,
an absolute value of an air permeation amount in the central portion is larger than an absolute value of an air permeation amount in a position of 1/10 of a length of the supplying roller in the longitudinal direction from each of the opposite end portions.

8. A manufacturing method of a supplying roller for supplying a developer to a developer carrying member in contact with the developer carrying member, comprising:
a step of undercoating a rod core metal with an adhesive;
a step of inserting the rod core metal into a first sponge roller having a first air permeation amount and a second sponge roller having a second air permeation amount smaller than the first air permeation amount so that the first sponge roller is provided in a central portion of the rod core metal with respect to a longitudinal direction of the rod core metal and the second sponge roller is provided in opposite end portions of the rod core metal with respect to the longitudinal direction; and
a step of bonding the second sponge roller disposed in one end portion with respect to the longitudinal direction and the first sponge roller together and bonding the second sponge roller disposed in the other end portion with respect to the longitudinal direction and the first sponge roller together.

9. An image forming apparatus for forming an image on a recording material, comprising:
an image bearing member configured to bear an electrostatic latent image;
a developer carrying member configured to carry a developer and configured to form a developer image by developing the electrostatic latent image with the developer;
a supplying roller configured to supply the developer to the developer carrying member in contact with the developer carrying member;
a regulating member configured to regulate the developer carried on the developer carrying member;
an accommodating chamber configured to hold the developer;
a developing chamber including the developer carrying member, the supplying roller, and the regulating member;
a development opening configured to communicate the developing chamber with the accommodating chamber;
a stirring shaft provided in the accommodating chamber;
a stirring member configured to stir the developer by being rotated about the stirring shaft in the accommodating chamber,
wherein the development opening is provided above a rotation axis of the supplying roller,
the stirring shaft is provided above the development opening, and
the supplying roller is larger in absolute value of an air permeation amount in a central portion thereof with respect to a longitudinal direction of the supplying roller than in a position of 1/10 of a length thereof from each of opposite end portions thereof with respect to the longitudinal direction; and
a controller configure to carry out control in which toner is discharged to an end portion region of the image bearing member with respect to a longitudinal direction of the image bearing member by the developer carried on the developer carrying member.

10. An image forming apparatus according to claim 9, wherein the controller carries out control in which the toner is discharged to only the end portion region of the image bearing member.

11. An image forming apparatus according to claim 9, wherein the controller carries out the control at a timing between a trailing end of a predetermined recording material and a leading end of a recording material fed subsequently to the predetermined recording material when image formation is continuously carried out and/or at a timing after the image formation is ended.

12. An image forming apparatus according to claim 9, wherein the image bearing member and the developer carrying member are in contact with each other even when image formation is not carried out.

13. An image forming apparatus according to claim 9, wherein the controller carries out the control every time when a number of recording materials subjected to image formation reaches a predetermined number of recording materials after the last control is carried out or every time when a number of rotations of the developer carrying member reaches a predetermined number of rotations after the last control is carried out.

14. An image forming apparatus according to claim 9, wherein the controller carries out the control on the basis of a print ratio when the image is formed on the recording material.

15. An image forming apparatus according to claim 14, wherein the controller does not carry out the control in a case where the print ratio exceeds a predetermined print ratio, and carries out the control in a case where the print ratio is the predetermined print ratio or less.

16. An image forming apparatus according to claim 9, wherein the end portion region is 0.5 L/min or more and less than 2.0 L/min in air permeation amount.

17. An image forming apparatus according to claim 9, wherein the controller is capable of causing the image forming apparatus to form images on recording materials of a plurality of sizes different with respect to the longitudinal direction and changes a length of the end portion region depending on the size of the recording material.

18. An image forming apparatus according to claim 17, wherein the recording materials of the plurality of sizes include the recording material of a first size with respect to the longitudinal direction and the recording material of a second size shorter in length in the longitudinal direction than the first size, and
wherein the controller makes a length of the end portion region when the image is formed on the recording material of the second size longer than a length of the end portion region when the image is formed on the recording material of the first size.

19. An image forming apparatus according to claim 18, wherein the controller is capable of carrying out feeding control in an operation in a first mode in which the recording material of the first size is fed at a first speed or an operation in a second mode in which the recording material of the second size is fed at a second speed slower than the second speed, and makes a length of the end portion region when the image is formed in the operation in the second mode longer than a length of the end portion region when the image is formed in the operation in the first mode.

20. An image forming apparatus according to claim 9, wherein the air permeation amount is 2.5 L/min or more and less than 4.5 L/min in the central portion of the supplying roller and is 0.5 L/min or more and less than 2.0 L/min in each of the opposite end portions of the supplying roller, and a ratio between the air permeation amount in the central portion and the air permeation amount in each of the opposite end portions is 1.25 or more and less than 9.0.
